(19) United States
(12) Patent Application Publication
(10) Pub. No.: US 2006/0008789 A1
(43) Pub. Date: Jan. 12, 2006

(54) E-learning course extractor

(76) Inventor: Wolfgang Gerteis, Karisruhe (DE)

Correspondence Address: FISH & RICHARDSON, P.C., PO BOX 1022, MINNEAPOLIS, MN, 55440-1022, US

(21) Appl. No.: 10/885,242

(22) Filed: Jul. 7, 2004

(51) Int. Cl. G09B 11/00; G09B 19/00; G09B 3/00

(52) U.S. Cl. 434/365; 434/81; 434/322; 434/219

(57) ABSTRACT

Creating an e-learning course includes receiving from a presentation tool a first set of one or more content items associated with a sequential order. A course structure is determined by associating one or more portions or content items of the first set of content items with course structural elements. A course that is associated with the course structure is extracted.

### TECHNICAL FIELD

The following description relates generally to e-learning and in particular to composition of an e-learning course.

### BACKGROUND

Systems and applications for delivering computer-based training (CBT) have existed for many years. However, CBT systems historically have not gained wide acceptance. A problem hindering the reception of CBT as a means of training workers and learners is the inflexibility of courses and training material.

Early CBT systems were based on hypermedia systems that statically linked content. User guidance was given by annotating the hyperlinks with descriptive information. The trainee could proceed through learning material by traversing the links embedded in the material. The structure associated with the material was very rigid, and the material could not be easily written, edited, or reused to create additional or new learning material.

Newer methods for intelligent tutoring and CBT systems are based on special domain models that must be defined prior to creation of the course or content. Once a course is created, the course material may not be easily adapted or changed for specific training needs of different learners. As a result, the course often fails to meet the needs of the trainee and/or trainer.

Furthermore, there is a vast amount of existing digital learning material that can be used for courses, however, because the existing material is inflexible or is formatted with no compatible data types, the material remains unused or may not be incorporated into courses without great expense and/or effort. Therefore, for the above and other reasons, new methods and technologies are needed to supplement traditional computer based training and instruction.

### SUMMARY

In one general aspect, creating an e-learning course includes receiving from a presentation tool a first set of one or more content items associated with a sequential order. A course structure is determined by associating one or more portions or content items of the first set of content items with course structural elements. A course that is associated with the course structure is extracted.

Implementations may include one or more of the following features. For example, the course structure may be determined by grouping one or more portions or content items of the first set of content items with course structural elements. The course may be extracted for importation into a course author tool.

The content items may include one or more types of presentation media. The types of presentation media may include text, a table, a graphic, an image, an audio clip, a video clip, and a slide.

The course structure may be determined by creating or editing the course structure. Editing the course structure may include grouping a portion of the first set of content items with a learning object, a knowledge item, or a sub course. Editing the course structure may include changing a title of a course structural element.

The course may be extracted by extracting course structure files and media files that correspond to the course. Extracting the course may include specifying the file format for the media files. Extracting the media files may include extracting media files in a file format supported by the presentation tool and a course author tool. Extracting the course may include storing the course structure files and media files in a manner that is compatible with a course author tool. The course structural elements may include learning objects and storing may include storing all files associated with a learning object inside a directory. The directory may contain a course structure file and one or more media files corresponding to knowledge items associated with the learning object. The media files may be extracted by modifying a presentation file compatible with the presentation tool and subsequently segmenting the presentation file into a plurality of media files.

The course may be extracted by storing portions or attributes of the content items as annotations or attributes of course structural elements. The content items may be slides in a slide show presentation. Lecture notes appended to each slide may be stored as annotations to structural elements corresponding to each slide. A digital image associated with each slide may be stored as a thumbnail image for a structural element corresponding to each slide.

The course may be modified using a course author tool. Modifying the course may include selecting to edit a course structural element and, in response to the selection, automatically launching the presentation tool to edit one or more content items associated with the course structural element. Modifying may include selecting to view a course structural element and, in response to the selection, automatically launching the presentation tool to view one or more content items associated with the course structural element.

The course may be extracted by extracting media files that correspond to the course structural elements of the course structure. The course may be modified using the course author tool by selecting to edit a media file corresponding to a course structural element and stored using a file extension, and automatically launching an application based on the file extension. The application may be used to edit the selected media file.

Creating an e-learning course may further include receiving from the presentation tool a second set of one or more content items associated with a sequential order. The second set corresponds to the first set further modified by the presentation tool. The course structure is automatically updated based on differences between the first set and the second set of one or more content items.

In another general aspect, a system for creating an e-learning course includes a presentation tool and an extractor. The presentation tool generates a first set of one or more content items associated with a sequential order. The extractor receives the set of one or more content items, enables a user to determine a course structure by associating one or more portions or content items of the set of content items with course structural elements, and extracts the course associated with the course structure.

Implementations may include one or more of the following features. For example, the system may further include a course author tool used to import the course and to enable a user to modify the course structural elements or relations between the course structural elements.

In another general aspect, a user interface includes three interface elements. A first interface element is used to enable perception of a set of one or more content items associated with a sequential order. A second interface element is used to enable determination of a course structure by associating one or more portions or content items of the set of content items with course structural elements in response to user manipulation, and a third interface element is used to enable extraction of a course associated with the course structure.

Implementations may include one or more of the following features. For example, the third interface element may enable extraction of the course for importation into a course author tool. The first interface element may graphically depict the set of content items as a group of content item symbols.

The second interface element may be a window that includes a tree view of the course structure. The tree view may graphically distinguish between different types of structural elements through indentation or through the use of different graphical symbols. The course structural elements may include at least one of a sub course, a learning object, and a knowledge item.

Other features will be apparent from the description, the drawings, and the claims.

### DESCRIPTION OF DRAWINGS

FIG. 1 is an exemplary course content aggregation model.

FIG. 2 is an example of an ontology of knowledge types.

FIG. 3 is an example of a course graph for e-learning.

FIG. 4 is an example of a sub-course graph for e-learning.

FIG. 5 is an example of a learning unit graph for e-learning.

FIGS. 6 and 7 are block diagrams of exemplary e-learning systems.

FIG. 8 is an exemplary course editor interface that may be implemented using an authoring tool.

FIG. 9 is an exemplary course overview of the course editor interface.

FIG. 10 is an exemplary dialog box of the course editor interface.

FIG. 11 is an exemplary workspace of the course editor.

FIG. 12 is an exemplary presentation tool interface.

FIGS. 13, 14, 15, 16, 17, 18 and 19 show examples of an edit course window used to develop a course structure for the presentation tool interface of FIG. 12.

FIG. 20 is an exemplary presentation tool interface directed to slide show presentations.

FIG. 21 is the presentation tool interface of FIG. 20 with an edit window used to develop a course structure.

FIGS. 22, 23, 24, 25 and 26 are exemplary screen shots for a course editor interface used to import an extracted course.

FIG. 27 is an exemplary course editor interface after importation of a course.

FIGS. 28, 29, 30, 31, 32, 33, 34 and 35 are exemplary screen shots for a course editor interface used to create an association between knowledge items and presentation tools.

Like reference symbols in the various drawings indicate like elements.

### DETAILED DESCRIPTION

E-Learning Content Structure

According to the implementations described below, an e-learning system and methodology structures content associated with a course or training so that the content is reusable and flexible. For example, the content structure allows the creator of a course to reuse existing content to create new or additional courses not only by reusing media but also by reusing (parts of) course structures. In addition, the content structure provides flexible content delivery that may be adapted to the needs of different learners. In particular, course content may be dynamically assembled into a temporary course as explained in detail below.

A course may be created from a number of learning objects associated with content that forms the course material. Each learning object may include information/data associated with the course and/or links to the data. The learning objects also may have associated metadata that may be used to describe attributes, characteristics, and/or qualities of the learning objects, in addition to relations to other learning objects. The learning objects may be organized and/or assembled to create a course (which may be presented to a learner). The learning objects and systems for creating and using the learning objects are described in U.S. application Ser. No. 10/184,111 filed Jun. 28, 2002, and titled E-LEARNING AUTHORING TOOL, which is a continuation-in-part of U.S. application Ser. No. 10/134,676, filed Apr. 30, 2002, and titled E-LEARNING SYSTEM, which claims priority to U.S. Provisional Application No. 60/354,945, filed Feb. 11, 2002, and titled FLEXIBLE INSTRUCTIONAL ARCHITECTURE FOR E-LEARNING, all of which are hereby incorporated by reference in their entirety for all purposes.

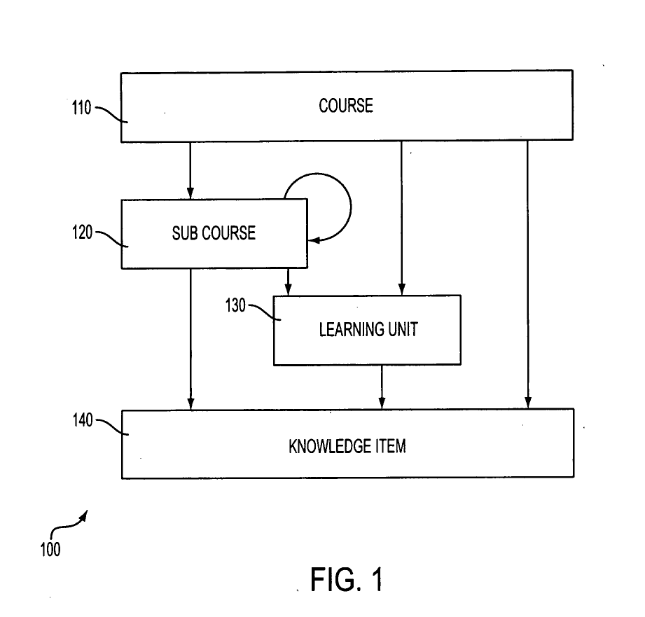

In one implementation, the e-learning objects may be implemented using one or more structural elements. Content associated with the course may be amassed using the structural elements arranged at different aggregation levels. Each higher level structural element may refer to any instances of all structural elements of a lower level. At its lowest level, a structural element refers to content and may not be further divided. According to one implementation shown in FIG. 1, course material 100 may be divided into four structural elements: a course 110, a sub-course 120, a learning unit 130, and a knowledge item 140.

Starting from the lowest level, knowledge items 140 are the basis for the other structural elements and are the building blocks of the course content structure. Each knowledge item 140 may include content that illustrates, explains, practices, or tests an aspect of a thematic area or topic. Knowledge items 140 typically are small in size (e.g., of limited duration).

A number of attributes may be used to describe a knowledge item 140, such as, for example, a name, a type of media, access rights, device capabilities, and a type of knowledge. The name may be used by a learning system to identify and locate the content associated with a knowledge item 140. The type of media describes the form of the content that is associated with the knowledge item 140. Since media is typically composed of different forms of content, the type of media provides an indication of the form that is generally considered the dominant, most important, or best for categorization purposes. For example, media types include a presentation type, a communication type, and an interactive type. A presentation media type may include a text, a table, an illustration, a graphic, an image, an animation, an audio clip, and a video clip. A communication media type may include a chat session, a group (e.g., a newsgroup, a team, a class, and a group of peers), an email, a short message service (SMS), and an instant message. An interactive media type may include a computer based training, a simulation, and a test. An access right may be used to determine whether to give access to a learner or other individual (e.g., a course author, an instructor, and/or a tutor).

A knowledge item 140 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the learner, and, therefore, provides general information for a better understanding of the structure of interrelated structural elements. Each of the knowledge types is described in further detail below.

Knowledge items 140 may be generated using a wide range of technologies, however, a browser (including plug-in applications) should be able to interpret and display the appropriate file formats associated with each knowledge item. For example, markup languages (such as a Hypertext Markup language (HTML), a standard generalized markup language (SGML), a dynamic HTML (DHTML), an extensible markup language (XML), or a specialization of XML such as the Vector Markup Language (VML)), JavaScript (a client-side scripting language), and/or Flash may be used to create knowledge items 140 and their associated data.

HTML may be used to describe the logical elements and presentation of a document, such as, for example, text, headings, paragraphs, lists, tables, or image references.

Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a learner.

Learning units 130 may be assembled using one or more knowledge items 140 to represent, for example, a distinct, thematically-coherent unit. Consequently, learning units 130 may be considered containers for knowledge items 140 of the same topic. A learning unit 130 also may be considered relatively small in size (e.g., of limited duration) though larger than a knowledge item 140.

Sub-courses 120 may be assembled using other sub-courses 120, learning units 130, and/or knowledge items 140. The sub-course 120 may be used to split up an extensive course into several smaller subordinate courses. Sub-courses 120 also may be used to build an arbitrarily deep nested structure by referring to other sub-courses 120.

Courses 110 may be assembled from all of the subordinate structural elements including sub-courses 120, learning units 130, and knowledge items 140. To foster maximum reuse and flexibility, all structural elements should be self-contained and context free.

Structural elements also may be tagged with metadata that is used to support adaptive delivery, reusability, and search/retrieval of content associated with the structural elements. For example, learning object metadata (LOM) defined by the IEEE “Learning Object Metadata Working Group” may be attached to individual course structure elements. The metadata also may be used to indicate learner competencies associated with the structural elements. Other metadata may include a number of knowledge types (e.g., orientation, action, explanation, and resources) that may be used to categorize structural elements.

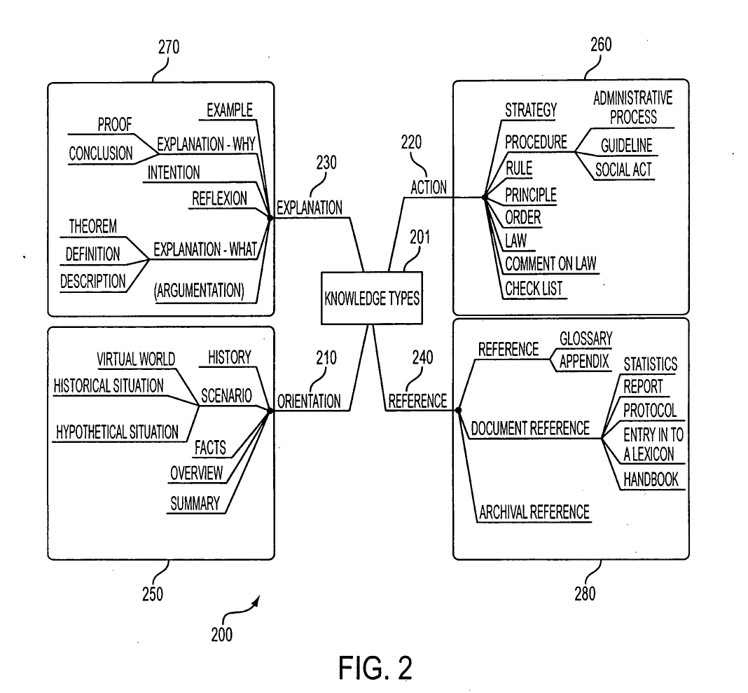

As shown in FIG. 2, structural elements may be categorized using a didactical ontology 200 of knowledge types 201 that include orientation knowledge 210, action knowledge 220, explanation knowledge 230, and reference knowledge 240. Orientation knowledge 210 helps a learner to find their way through a topic without being able to act in a topic-specific manner and may be referred to as “know what.” Action knowledge 220 helps a learner to acquire topic related skills and may be referred to as “know how.” Explanation knowledge 230 provides a learner with an explanation of why something is the way it is and may be referred to as “know why.” Reference knowledge 240 teaches a learner where to find additional information on a specific topic and may be referred to as “know where.”

The four knowledge types (orientation, action, explanation, and reference) may be further divided into a fine grained ontology as shown in FIG. 2. For example, orientation knowledge 210 may refer to sub-types 250 that include a history, a scenario, a fact, an overview, and a summary. Action knowledge 220 may refer to sub-types 260 that include a strategy, a procedure, a rule, a principle, an order, a law, a comment on law, and a checklist. Explanation knowledge 230 may refer to sub-types 270 that include an example, a intention, a reflection, an explanation of why or what, and an argumentation. Reference knowledge 240 may refer to sub-types 280 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed.

Relations may be divided into two categories: subject-taxonomic and non-subject taxonomic. Subject-taxonomic relations may be further divided into hierarchical relations and associative relations. Hierarchical relations may be used to express a relation between structural elements that have a relation of subordination or superordination. For example, a hierarchical relation between the knowledge items A and B exists if B is part of A. Hierarchical relations may be divided into two categories: the part/whole relation (i.e., “has part”) and the abstraction relation (i.e., “generalizes”). For example, the part/whole relation “A has part B,” describes that B is part of A. The abstraction relation “A generalizes B” implies that B is a specific type of A (e.g., an aircraft generalizes a jet or a jet is a specific type of aircraft).

Associative relations may be used refer to a kind of relation of relevancy between two structural elements. Associative relations may help a learner obtain a better understanding of facts associated with the structural elements. Associative relations describe a manifold relation between two structural elements and are mainly directional (i.e., the relation between structural elements is true only in one direction). Examples of associative relations include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B)). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non subject-taxonomic relations may include the relations “prerequisite of” and “belongs to.” The “prerequisite of” and the “belongs to” relations do not refer to the subject-taxonomic interrelations of the knowledge to be imparted. Instead, these relations refer to the progression of the course in the learning environment (e.g., as the learner traverses the course). The “prerequisite of” relation is directional whereas the “belongs to” relation is non-directional. Both relations may be used for knowledge items 140 that cannot be further subdivided. For example, if the size of the screen is too small to display the entire content on one page, the page displaying the content may be split into two pages that are connected by the relation “prerequisite of.”

Another type of metadata is competencies. Competencies may be assigned to structural elements, such as, for example, a sub-course 120 or a learning unit 130. The competencies may be used to indicate and evaluate the performance of a learner as the learner traverse the course material. A competency may be classified as a cognitive skill, an emotional skill, an senso-motorical skill, or a social skill.

Course Graphs

The content structure associated with a course may be represented as a set of graphs. A structural element may be represented as a node in a graph. Node attributes are used to convey the metadata attached to the corresponding structural element (e.g., a name, a knowledge type, a competency, one or more cost elements, access rights, device type, and/or a media type). A relation between two structural elements may be represented as an edge.

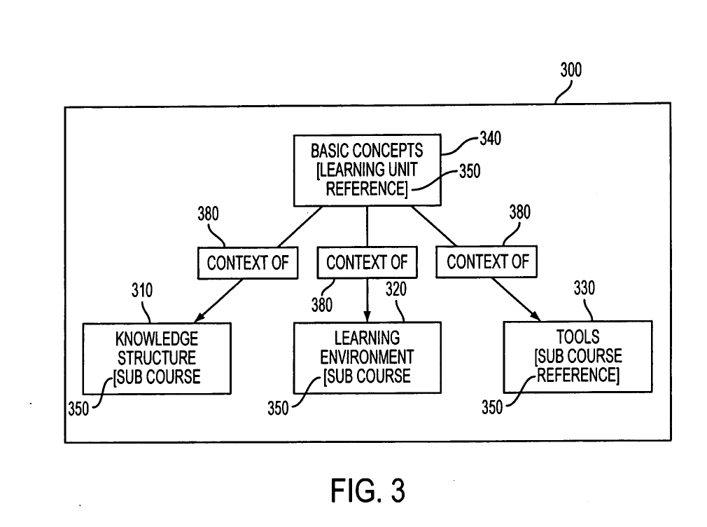

For example, FIG. 3 shows a graph 300 for a course. The course is divided into four structural elements or nodes (310, 320, 330, and 340): three sub-courses (e.g., knowledge structure 310, learning environment 320, and tools 330) and one learning unit (e.g., basic concepts 340). A node attribute 350 of each node is shown in brackets (e.g., the node 340 labeled “Basic Concepts” has an attribute 350 that identifies it as a reference to a learning unit). In addition, an edge 380 expressing the relation “context of” has been specified for the learning unit 340 with respect to each of the sub-courses (310, 320, 330). As a result, the basic concepts explained in the learning unit 340 provide the context for the concepts covered in the three sub-courses (310, 320, 330).

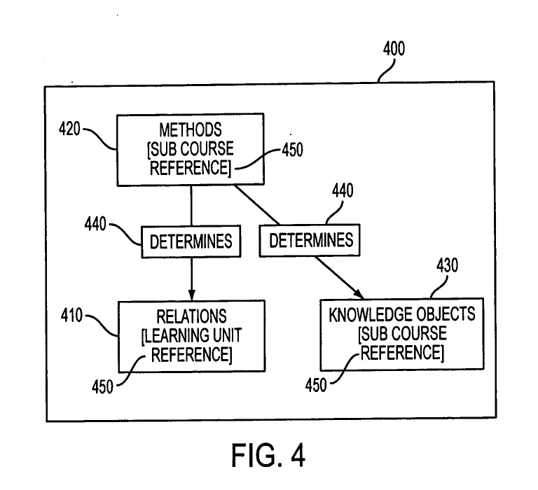

FIG. 4 shows a graph 400 of the sub-course “Knowledge structure” 310 of FIG. 3. In this example, the sub-course “Knowledge structure” is further divided into three nodes (410, 420, and 430): a learning unit (e.g., on relations 410) and two sub-courses (e.g., covering the topics of methods 420 and knowledge objects 430). The edge 440 expressing the relation “determines” is provided between the structural elements (e.g., the sub-course “Methods” 420 determines the sub-course “Knowledge objects” 430 and the learning unit “Relations” 410). In addition, the attribute 450 of each node (410, 420, 430) is shown in brackets (e.g., nodes “Methods” and “Knowledge objects” have the attribute identifying them as references to other sub-courses; node “Relations” has the attribute of being a reference to a learning unit).

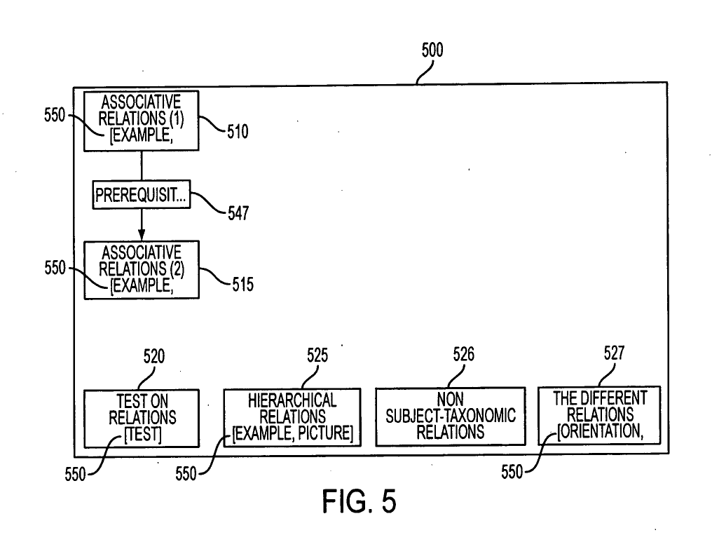

FIG. 5 shows a graph 500 for the learning unit “Relations” 450 shown in FIG. 4. The learning unit includes six nodes (510, 515, 520, 525, 526 and 527): six knowledge items (i.e., “Associative relations (1)”, “Associative relations (2)”, “Test on relations”, “Hierarchical relations”, “Non subject-taxonomic relations”, and “The different relations”). An edge 547 expressing the relation “prerequisite” has been provided between the knowledge items “Associative relations (1)” 510 and “Associative relations (2)” 515. In addition, attributes 550 of each node are specified in brackets (e.g., the node “Hierarchical relations” 525 includes the attributes “Example” and “Picture”).

E-Learning Strategies

The above-described content aggregation and structure associated with a course does not automatically enforce any sequence that a learner may use to traverse the content associated with the course. As a result, different sequencing rules may be applied to the same course structure to provide different paths through the course. The sequencing rules applied to the knowledge structure of a course are called learning strategies. The learning strategies may be used to pick specific structural elements to be suggested to the learner as the learner progresses through the course. The learner or supervisor (e.g., a tutor) may select from a number of different learning strategies while taking a course. In turn, the selected learning strategy considers both the requirements of the course structure and the preferences of the learner. As a result, the progression of learners through the course may differ.

Learning strategies may be created using macro-strategies and micro-strategies. A learner may select from a number of different learning strategies when taking a course. The learning strategies are selected at run time of the presentation of course content to the learner (and not during the design of the knowledge structure of the course).

Micro-strategies are used in learning strategies to refer to the coarse-grained structure of a course (i.e., the organization of sub-courses 120 and learning units 130). The macro-strategy determines the sequence that sub-courses 120 and learning units 130 of a course are presented to the learner. Basic macro-strategies include “inductive” and “deductive,” which allow the learner to work through the course from the general to the specific or the specific to the general, respectively. Other examples of macro-strategies include “constructivistic” and “table of contents.”

Micro-strategies, implemented by the learning strategies, target the learning progression within a learning unit. The micro-strategies determine the order that knowledge items of a learning unit are presented. Micro-strategies refer to the attributes describing the knowledge items. Examples of micro-strategies include “orientation only”, “action oriented”, “explanation-orientated”, and “table of contents”.

E-Learning System

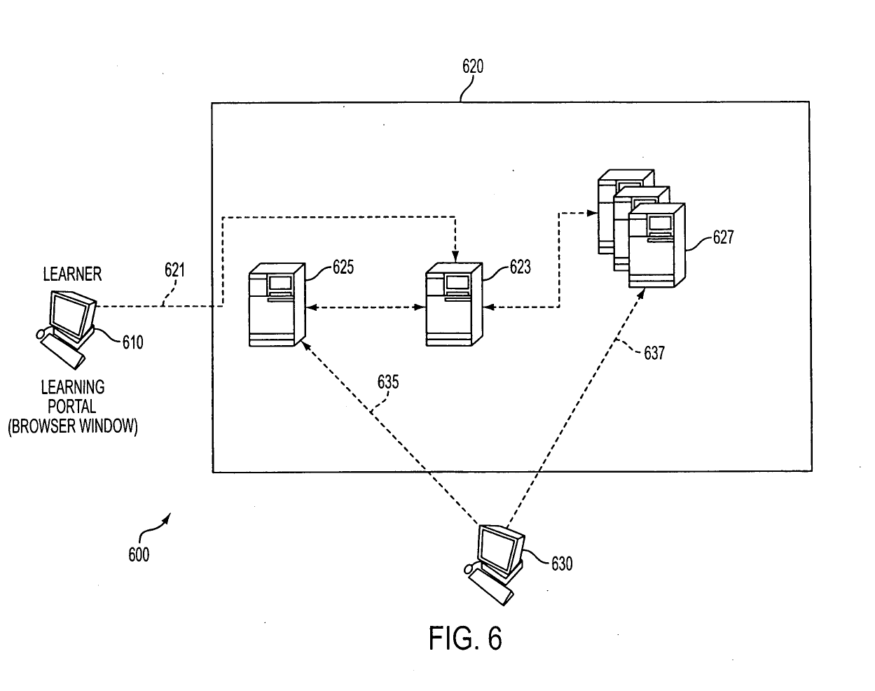

As shown in FIG. 6, an e-learning architecture 600 may include a learning station 610 and a learning system 620. The learner may access course material using the learning station 610. The learning station 610 may be implemented using any general purpose computer that is capable of executing instructions in a defined manner including: a special purpose computer, a personal computer, a work station, a programmable logic device or a portable computing device. The learning station 610 may execute any number of software applications, including an application that is configured to access, interpret, and present courses and related information to a learner.

The learning station 610 may include a browser to implement a learning portal that allows a learner to access the learning system 620. A communications link 621 between the learning station 610 and the learning system 620 may be configured to send and receive signals (e.g., electrical, electromagnetic, or optical) that convey or carry data streams representing various types of analog and/or digital content. For example, the communications link 621 may be implemented using a plain old telephone service (POTS) line network, a digital subscriber line (DSL) network, an integrated services digital network (ISDN), and a synchronous optical network (SONET), or combinations of two or more of these networks. In addition, the communications links may include a wireless link using electromagnetic signals, such as, for example, radio, infrared, and microwave signals, to convey information. The communications link 621 also may include one or more networks or network devices (e.g., servers, routers, switches, hubs, repeaters, and storage devices).

The learning system 620 may include one or more servers. As shown in FIG. 6, the learning system 620 includes a learning management system 623, a content management system 625, and an administration management system 627. Each of these systems may be implemented using one or more servers, processors, or intelligent network devices. In addition, an authoring station 630 may be provided to create courses from structural elements.

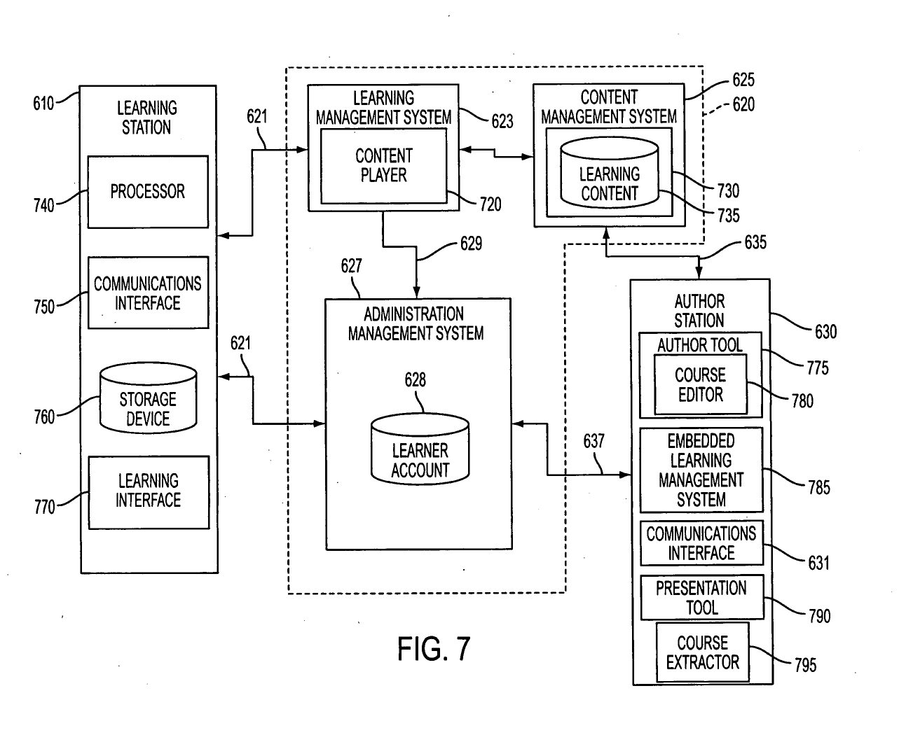

As shown in FIG. 7, the administration management system 627 may be implemented using a server, such as, for example, the SAP R/3 4.6C+LSO Add-On. The administration management system 627 includes a database 628 of learner accounts and course information. For example, the learner account may include demographic data about the learner (e.g., a name, an age, a sex, an address, a company, a school, an account number, and a bill) and his/her progress through the course material (e.g., places visited, tests completed, skills gained, knowledge acquired, and competency using the material). The administration management system 627 also may provide additional information about courses, such as a course title, a description, courses offered, a course catalog the author/instructor of a course, and a list of the most popular courses.

The content management system 625 may include a learning content server 730. The learning content server 730 may be implemented using a WebDAV server. The learning content server may include a content repository 735. The content repository stores course files and media files that are used to present a course to a learner at the learning station 610. The course files may include the structural elements that make up a course and may be stored as XML files. The media files may be used to store the content that is included in the course and assembled for presentation to the learner at the learning station 610.

The learning management system 623 may include a content player 720. The content player 720 may be implemented using a server, such as an SAP J2EE Engine. The content player 720 is used to obtain course material from the content repository 735. The content player 720 also applies the learning strategies to the obtained course material to generate a navigation tree or path for the learner. The navigation tree or path is used to suggest a route through the course material for the learner and to generate a presentation of course material to the learner based on the learning strategy selected by the learner.

The learning management system 623 also may include an interface 629 for exchanging information with the administration management system 627. For example, the content player 720 may update the learner account information as the learner progresses through the course material to indicate, for example, competencies gained, tests passed, courses completed.

Learning Station

The learner may access information about a course, content associated with a course, information about the learning system 620, and information about the learner (e.g., the learner account) using the learning station 610. As shown in FIG. 7, the learning station 610 may include a processor 740, a communications interface 750, and a storage device 760. The learning station 610 also may include any number of peripherals or integrated devices (not shown) (e.g., displays, memory/storage devices, input devices, ports/interfaces, printers, communication interfaces, and speakers) that facilitate access to, presentation of, and interaction with the course, its content, and associated course information.

The processor 740 may be used to implement a learning interface 770. For example, the processor 740 may execute any number of software applications including a learning interface that is configured to access, interpret, and present a course and associated information to a learner, and to allow a learner to interact with the content and the learning system 620.

The learning station 610 may be provided with a number of software applications. The software may include a browser, such as, for example, Netscape® Communicator, Microsoft® Internet Explorer, or any other software application that may be used to interpret and process a markup language, such as HTML, SGML, DHTML, XML, or XHTML. The browser also may include software plug-in applications that allow the browser to interpret, process, and present different types of information. The browser may include any number of application tools, such as, for example, Java™, ActiveX™, JavaScript™, and Flash™.

The communications interface 750 may facilitate the exchange of data and information between the learning station 610 and the learning system 620. For example, the communications interface may be a communications card, a modem, a port, a transceiver or a device that is able to transmit and receive data using the communications link 621. Data may be received from the learning system 620 and processed by the processor 740 and/or stored in the storage device 760. Similarly, data processed by the processor 740 and/or stored in the storage device 760 may be transmitted to the learning system 620.

As described above, the learner may contact the learning system 620 using the learning station 610 to access a course. The learning interface 770 and associated browser may be used to implement a graphical user interface that accepts information input from the learner and presents information received from the learning system 620. The learning interface 770 also may be provided with a content player to present courses that are downloaded from the learning system 620 to the storage device 760.

Course Author Station

As shown in FIGS. 6 and 7 an e-learning system may also include an author station 630. The author station 630 may be implemented using a workstation, a computer, a portable computing device, or any intelligent device capable of executing instructions and connecting to a network. The author station 630 may include any number of devices and/or peripherals (e.g., displays, memory/storage devices, input devices, interfaces, printers, communication cards, and speakers) that facilitate access to, presentation of, and creation of courses and their associated content.

The author station 630 may execute any number of software applications including an author tool 775 that is configured to create, access, interpret, and present courses (and related course data/information). The author tool 775 may include a course editor 780 and a browser, such as, for example, Netscape® Communicator, Microsoft® Internet Explorer, or any other software application that may be used to interpret and process a markup language, such as HTML, SGML, DHTML, or XML. The browser also may include software plug-in applications that allow the browser to interpret, process, create, and present different types of information. The browser may include any number of application tools, such as, for example, Java™. ActiveX™, JavaScript™, and Flash™.

The course author tool 775 may access content and associate the content with structural elements. The author tool 775 also may associate knowledge types, relations, and metadata with the structural elements. The author tool 775 may be used to build the structure of a course, i.e., its structural elements and relations. The author tool 775 may save the structural elements and metadata as course files and the associated content as media files.

The author station 630 also may include a presentation tool 790 configured to create presentation media and store the presentation media in a format associated with the presentation tool 790. A course extractor 795 is configured to organize the presentation media developed by the presentation tool 790 into an initial course structure and generate a corresponding set of media files and course structure files formatted for subsequent importation into the course editor 780. The presentation tool 790 is typically programmatically extendable. Once imported, the initial course structure may be modified and refined using the course editor 780. In one implementation, the presentation tool 790 is Microsoft® PowerPoint® (which is extendable by Visual Basic) and the course extractor 795 is a software plug-in. In this implementation, the presentation media are PowerPoint® presentation slides that may be stored as HTML files or as PowerPoint® slide formatted files (i.e., PPS files). Each PowerPoint(® presentation slide may include text, a table, an illustration, a graphic, an image, an animation, an audio clip, a video clip, or any combination thereof.

The author station 630 also may include an embedded learning management system 785. The embedded learning management system 785 is an application program that is similar to the learning management system 623 and enables the author to preview a course by applying learning strategies to the course (e.g., that is being created/modified by the author) in order to view the navigation path that is suggested to a learner based on the applied strategy. Based on the different provided strategies, the author may determine how to create structure for the course and how the created structure is interpreted by the learning management system 623. As a result, the author may edit, modify, or add structure to the course before publishing the course to the learning system 620.

The author station 630 also may include a communications interface 631. After a course is created, the author station 630 may use the communication interface 631 to connect to the learning system 620 to publish the course so that a learner may enroll and take the course. In particular, the communication interface 631 of the author station 630 may connect to the content management system 625 using a communications link 635. To publish the course on the learning system 620, the author station 630 transfers the course structure and content (e.g., the course files and media files) to the content management system 625. As previously described, the course files may be formatted according to a markup language (e.g., XML). The communications link 635 may be implemented using any permanent or temporary communications link configured to transfer the course files and associated media files (e.g., a communications medium configured to transfer data signals as electrical, electromagnetic, or optical signals). The content management system 625 stores the course files and associated media files in the content repository 735 for access by the content player 720.

The communication interface 631 of the author station 630 also may connect to the administration management system 627 using a communication link 637. The communication link may be implemented by any communication medium that may be configured to send and receive signals (e.g., electrical, electromagnetic, or optical). The author station 630 provides the administration management system 627 with course information (e.g., title, author, description, credits, prerequisites, and competencies gained/required) that is used by a learner, for example, to book a course. Once the course is published, the administration management system 627 makes the course information available to the learning station 610 using the learning portal.

Course Editor

The author tool 775 and author station 630 may include a course editor 780 that can be used in conjunction with a browser to create, modify, build, assemble, and preview course structures and their associated content. The course editor 780 may be used to structure content for use in a course. The course editor 780 includes a course editor interface.

The course editor 780 may be used to create the structure for the course content. The structure may be saved as metadata. The metadata may be interpreted by the content player 720 of the learning management system 623 to present a course to a learner according to a learning strategy selected at run time. In particular, the course editor 780 enables the author to classify and describe structural elements, assign attributes to structural elements, assign relations between structural elements, and build a subject-taxonomic course structure. The course editor 780 primarily generates the structure of the course and not structure of the content (although structure of content may be provided for as well).

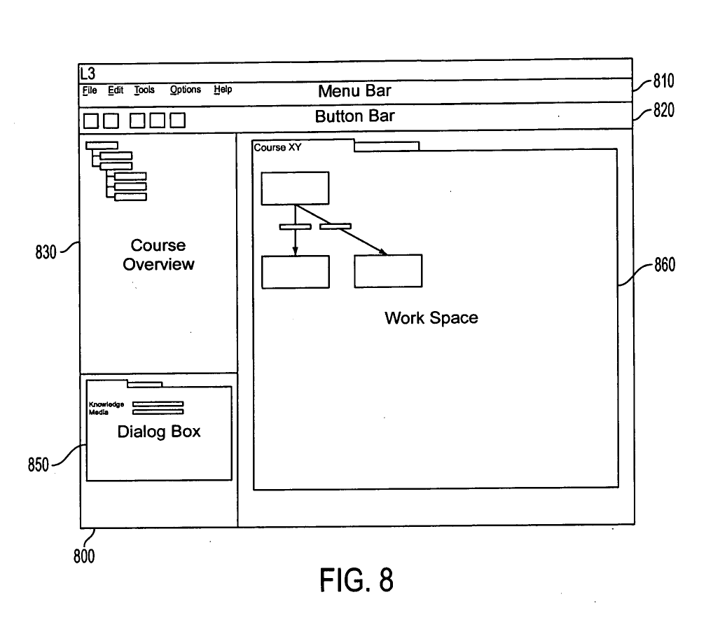

As shown in FIG. 8, the course editor interface 800 may include a menu bar 810, a button bar 820, a course overview 830, a dialog box 850, and a work space 860. The menu bar 810 may include various drop-down menus, such as, for example, file, edit, tools, options, and help. The drop-down menus may include functions, such as create a new course, open an existing course, edit a course, or save a course. The button bar 820 may include a number of buttons. The buttons may be shortcuts to functions in the drop down menus that are used frequently and that are active tools and functions for use with the course editor 780. The remaining portions of the course editor interface 800 may be divided in to three primary sections or windows: the course overview 830, the dialog box 850, and the workspace 860. Each of the sections may be provided with horizontal or vertical scroll bars or other means allowing the windows to be sized to fit on different displays while providing access to elements that may not appear in the window.

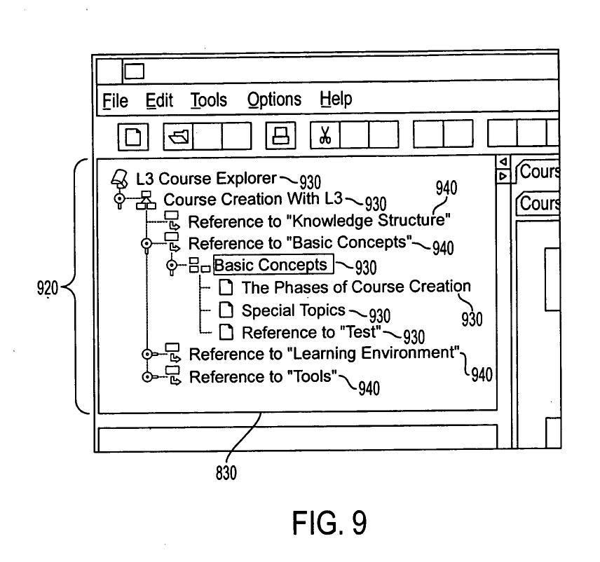

As shown in FIG. 9, the course overview 830 (shown as an excerpt from the course editor interface 800) may be used to select and view components within a course. The author may select various components within the course overview 830 to open and close the components, for example, the structural elements. The components in the course overview 830 may be arranged in an explorer format. The course overview 830 may include a directory 920 of components including files and folders. Files and folders may be expanded to view their contents. However, unlike an explorer, the course overview 830 distinguishes between structural elements 930 and relations 940 (e.g., which may contain learning content). Sub-courses 120, learning units 130, and knowledge items 140, as well as their relations, may be displayed in the course overview 830 using icons. To access a sub-course 120 or learning unit 130 shown in the overview, the author may right click and select open sub-course 120 or learning unit 130. Knowledge items 140 may be opened by double clicking on the associated icon.

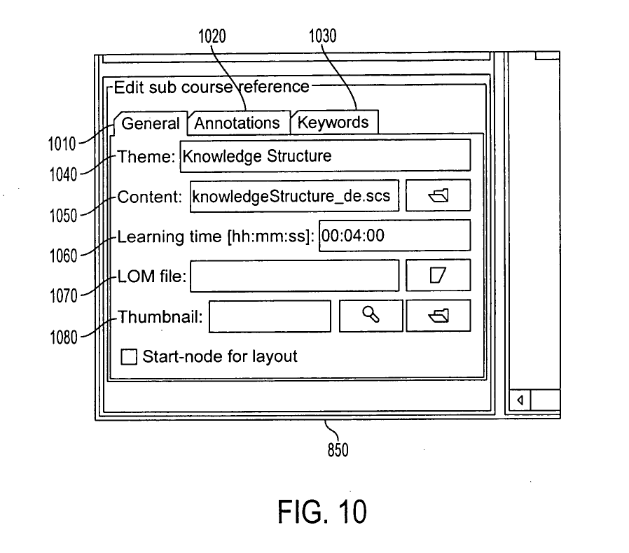

As shown in FIG. 10, the dialog box 850 (shown as an excerpt from the course editor interface 800) may be used to interact with and edit course components. For example, the dialog box 850 may be arranged with tabs (e.g., general, annotations, keywords, and competency) that may be used to describe the structural elements. Each tab may be used to edit a structural element. The dialog box 850 shown in FIG. 10 includes the tabs general 1010, annotations 1020, and keywords 1030. The dialog box 850 shown in FIG. 10 also includes the fields theme 1040, content 1050, learning time 1060, LOM file 1070, and thumbnail 1080. An author may add content (e.g., an HTML page) and attributes (e.g., a name, a knowledge type, a media type, a LOM, and a competency) to the structural elements using the dialog box 850. The dialog box 850 is automatically configured to correspond to any structural element that has been selected or created in the workspace 860.

The general tab 1010 enables the author to determine general information and/or attributes that are associated with a selected structural element. A name of a structural element may be provided in a name field (not shown). A thumbnail 1080 may be used to give the author an impression of the content associated with the structural element. A theme 1040 may be included to describe a topic, an attribute, or a knowledge type of the structural element. A learning time 1060 may be used to indicate the average amount of time that a learner may need to complete the content associated with the structural element. A LOM file 1060 may be included to add comprehensive metadata to the structural element.

A competency tab (not shown) may be used to classify competencies that are acquired by completing or viewing the structural elements. Examples of competencies include, cognitive, emotional, sensomotoric, and social. Competencies also may be included that are needed or recommended to use the associated structural element.

The annotations tab 1020 may be used to insert comments regarding the content associated with a structural element. For example, notes or a description of the content associated with the structural element may be inserted. The keyword tab 1030 may be used to enter keywords that are used to search for and/or organize structural elements. Keywords also may be used to classify a structural element.

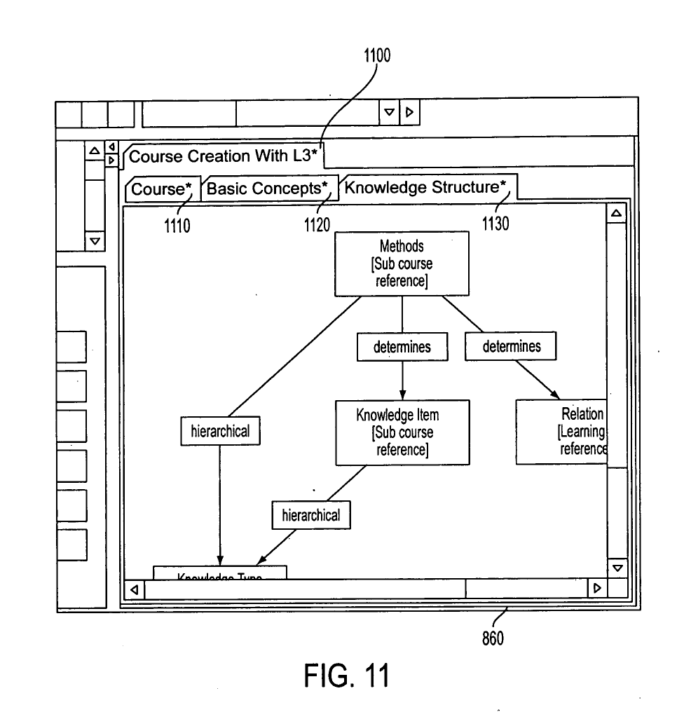

As shown in FIG. 11, the workspace 860 (shown as an excerpt from the course editor interface 800) may be used to create the structure of a course. The workspace 860 displays structural elements and relations between the structural elements. Structural elements selected in the course overview 830 may be displayed in the workspace 860. Similarly, new structural elements and any associated relation may be created in the workspace 860.

Structural elements may be represented in the workspace 860 as rectangles. The rectangles may be color coordinated to indicate the type of structural element (e.g., sub-course 120, learning unit 130, knowledge item 140) and whether the structural element is selected or active. Alternatively, the structural elements may be represented in the workspace by a thumbnail indicative of the content associated with the structural element (e.g., as specified in 1080). Relations may be indicated as lines (i.e., non directional relations) or arrows (i.e. directional relations). The displayed rectangles, lines, and arrows may be labeled with a corresponding name (e.g., assigned using the dialog box 850). The workspace 860 also may include tabs 1110, 1120, 1130 that correspond to each aggregation level. For example, the structural elements belonging to each aggregation level may be accessed by selecting a corresponding tab 1110, 1120, 1130.

As shown in FIG. 11, the tab 1100 labeled “Course Creation With L3” indicates the course that is currently viewed in the workspace. The tabs “course” 1110, “basic concepts” 1120, and “knowledge structure” 1130 correspond to the aggregation levels within the course. The tab “knowledge structure” 1130 is selected and the corresponding structural elements and relations are shown. The tab may be populated with a name corresponding to a structural element or aggregation level, which may be assigned using the dialog box 850.

Structural elements may be added to a course and structured using the workspace 860. For example, a pop-up menu (not specifically shown) may be accessed by right clicking a mouse button while pointing within the workspace 860. The pop-up menu (not specifically shown) may include any available structural elements that may be added to the selected tab. To generate a structural element, the author selects the appropriate button or menu item from the pop-up menu corresponding to the type of structural element to be added.

For example, to generate a sub-course 120, the author may select a menu item labeled “new sub-course” (e.g. sub-course 120) from the pop-up menu. Upon selecting the menu item “new sub-course”, the menu presents a choice of Empty or User. The Empty option may be selected to open an empty sub-course rectangle 120. The User option may be selected to open a sub-course 120 with predefined content, such as learning units 130 and/or knowledge items 140. A dialog box 850 corresponding to the sub-course 120 is then automatically configured and displayed. Using the corresponding dialog box 850 the author may enter a name, attributes, annotations, and keywords for the new sub-course 120. The new sub-course 120 is then added to the course overview 830 and a rectangle with the color-coding corresponding to a sub-course (e.g. green) is added to the workspace 860.

To generate a learning unit 130, the author may select a menu item labeled “new learning unit” (e.g. learning unit 130) from the pop-up menu. Upon selecting the menu item “new learning unit”, the menu presents a choice of Empty or User. The Empty option may be selected to open an empty learning unit 130. The User option may be selected to open a learning unit 130 with predefined content, such as knowledge items 140. A corresponding dialog box 850 prompts the author to enter a name, attributes, annotations, and keywords for the learning unit 130. The learning unit 130 is then displayed in the course overview 830 and appears as a rectangle with the corresponding color-coding (e.g. violet) in the workspace 860.

To generate a knowledge item 140, the author may select a menu item labeled “new knowledge item” (e.g. knowledge item 140) from the pop-up menu. For example, selecting the menu item “new knowledge item” automatically configures a dialog box 850 corresponding to the knowledge item 140. The dialog box 850 may be used to enter a name, attributes, annotations, and keywords corresponding to the knowledge item 140. The knowledge item 140 is then displayed in the course overview 830, and the workspace 860 is populated with a rectangle with the corresponding color-coding (e.g. brown). The dialog box 850 also enables the author to assign content to the knowledge item 140. For example, the content field 1050 in the dialog box 850 may be used to establish a reference to a media file corresponding to the knowledge item 140. The media file may be any media that may be displayed by a browser. The author also may assign an appropriate knowledge type (e.g., orientation, explanation, action, reference) and media type (e.g., text, images, diagrams, pictures, sounds, films, video, audio, chat groups, email, video conferences, whiteboards, phones, and PDAs) to the knowledge item 140.

As part of this implementation, the pop-up menu also may be used to create tests and collaborative scenarios. For example, when “test” is selected from the pop-up menu a new dialog box 850 appears. The dialog box 850 may include the tabs general, test parameters, annotations, and keywords. The user may use the general tab to insert a name, content, time, and LOM file that will be associated with the test. In addition, a rectangle box labeled “test” with the corresponding color-coding appears in the workspace 860. The test parameters tab may be used to indicate a type of test (e.g., pre-test, exercise, self test, or post test). A collaboration scenario may be used to provide an opportunity for the learner to interact with other learners.

To create a relation between structural elements, the author selects a structural element in the workspace 860. The author then selects a relation from the pop-up menu. The author may drag a line or arrow corresponding to the relation from the selected structural element to a second structural element. The author also may edit and remove unwanted relations by selecting an existing relation in the workspace and using the pop-up menu to edit or delete the relation.

After creating the course design and the associated course structure, the author may activate the embedded learning management system 785 to preview the course. The embedded learning management system 785 applies selected strategies to the course. To preview the course, the author activates the embedded learning management system 785 using the authoring tool 775. The author then selects a strategy. The embedded learning management system 785 applies the selected strategy to the course structure and determines a navigation path. The navigation path is presented to the author (in a manner that is similar to the display a learner would receive). The author may continue to select other strategies and view the corresponding course navigation path views. Once the author is satisfied with the course structure, the author may transfer the course to the learning system 620 to publish the course.

Presentation Tool and Course Extractor

The author station 630 may include a presentation tool 790 that can be used in conjunction with a course extractor 795 to organize presentation media into an initial course and generate corresponding course structure files and media files. The course structure files and media files are formatted to allow subsequent importation into the course editor 780 and content player 720. The presentation tool 790 includes a presentation tool interface that allows a user to create, modify, save, and delete presentations. A presentation is a set of content items (e.g., any type of presentation media including a text, a table, an illustration, a graphic, an image, an audio clip, a video clip, or any combination thereof) grouped together in a format that may be accessed and used by a presentation tool.

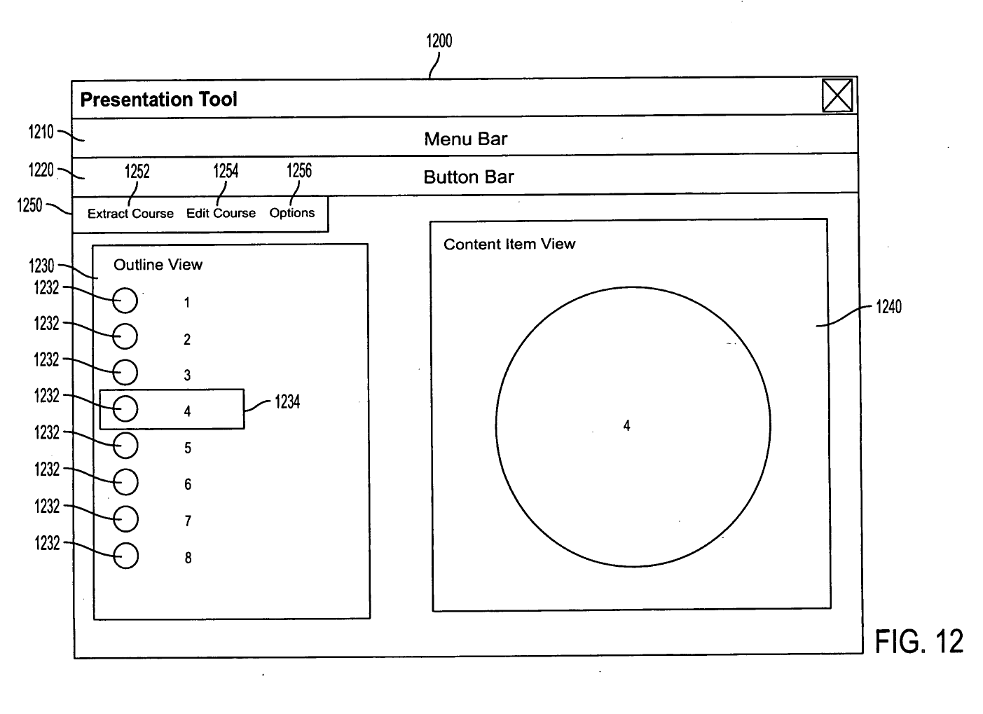

As shown in FIG. 12, a presentation tool interface 1200 may include a menu bar 1210, a button bar 1220, an outline view 1230, a content item view 1240, and a course extractor bar 1250. The menu bar 1210 may include various drop-down menus, such as, for example, file, edit, format, tools, and help. The drop-down menus may include functions, such as create a new presentation, open an existing presentation, edit a presentation, or save a presentation. The button bar 1220 may include a number of buttons. The buttons may be shortcuts to functions in the drop down menus that are used frequently and are active tools for use with the presentation tool 1200.

The outline view 1230 may be a window or a section that shows an outline of the presentation. The outline typically consists of a set of content item symbols 1232 in sequential order. Each symbol 1232 is associated with a particular content item 1234 and may include a graphical element (e.g., an icon) and/or a label. In one implementation, the content items 1234 referenced by the symbols 1232 include video clips of class lectures, and the symbols 1232 are camera icons with labels stating the corresponding class number, title, and date (e.g., “class 2—Orientation—11/2/02”). In another implementation, the content items 1234 referenced by the symbols 1232, include video clips of class lectures and, alternatively or additionally, include audio clips of class lectures. In yet another implementation, the content items 1234 referenced by the symbols 1232 are slides in a slide show presentation, each of which may include or be associated with various media formats, such as text, tables, animations, audio clips, and video clips.

The content item view 1240 may be a window or an area that presents a more detailed understanding of a selected content item 1234. The user may select a given content item through the use of the menu bar 1210, the button bar 1220, or by selecting the symbol 1232 that corresponds to the content item in the outline view 1230. The content item view 1240 may depict the actual content item or attributes associated with the content item.

In one implementation, the content item is a video clip, and the video clip may be viewed in the content item view 1240. The menu bar 1210, button bar 1220, and/or pop-up menus may be used to perform functions related to video content such as, for example, play, fast forward, rewind, pause, record, skip to end of chapter, and bookmark.

In another implementation, the content item is an audio clip, and the content item view 1240 shows various audio-related parameters such as, for example, audio tracks, an equalizer, volume, and one or more bars indicating progression through the audio clip. The menu bar 1210, button bar 1220, and/or pop-up menus may be used to perform functions related to audio content such as, for example, play, fast forward, rewind, pause, record, and set audio levels (e.g., bass, treble, and balance).

In yet another implementation, the content item is a presentation slide, and the content item view 1240 may show a detailed view of the selected presentation slide. The menu bar 1210, button bar 1220, and/or pop-up menus may be used to perform functions that create, add to, and modify the contents of the slide by, for example, creating, adding, and/or modifying text, tables, pictures, graphics, audio clips, video clips, and/or animations in the slide.

Both the outline view 1230 and the content item view 1240 may include horizontal and/or vertical scroll bars or other means allowing all elements associated with the window to be viewed and accessed. The windows also may be sized to fit on different displays while providing access to the elements that may not appear in the window. In some implementations, the presentation tool 1200 includes either the outline view 1230 or the content item view 1240, but not both. The content items, however, are still organized in sequential order by the presentation tool 1200, even if the order of the content items is not graphically depicted in an outline view 1230.

The course extractor bar 1250 includes an extract course virtual button 1252, an edit course virtual button 1254, and an options drop down menu 1256. The course extractor bar 1250 and associated functions may be provided by the course extractor 795 as a software add-on to the presentation tool 790.

The extract course button 1252 may be selected to extract the presentation by creating a course structure file and one or more associated media files that are compatible with the course editor 780 and the content player 720. Selecting the extract course button 1252 without prior editing of the presentation as a course (e.g., using the edit course window 1300 discussed below) results in extraction of the presentation as a course containing one learning object. The label of the first content item in the sequence may be used as the title of the learning object. Each content item in the presentation may be stored as a knowledge item associated with the learning object. The titles of the knowledge items are the labels of the corresponding content items. For example, if the presentation includes three content items labeled “content item 1,”, “content item 2,”, and “content item 3,”, then the resulting initial course structure includes a learning object titled “content item 1” that contains three knowledge items titled “content item 1,”, “content item 2,”, and “content item 3,”.

The options drop down menu 1256 includes options that relate to and/or may be used to modify the extraction process, such as, for example, an option to specify the preferred media file format used for extraction and an option to use portions or attributes of the content items as annotations or attributes of corresponding knowledge items/structural elements. In one implementation, the content items are slides in a slide show presentation, and the lecture notes appended to each slide are extracted and included as annotations of the knowledge items corresponding to each slide. Additionally or alternatively, the options may provide for generation of a digital image for each slide which, upon extraction, may be stored as a media file and included as a thumbnail for the corresponding knowledge item.

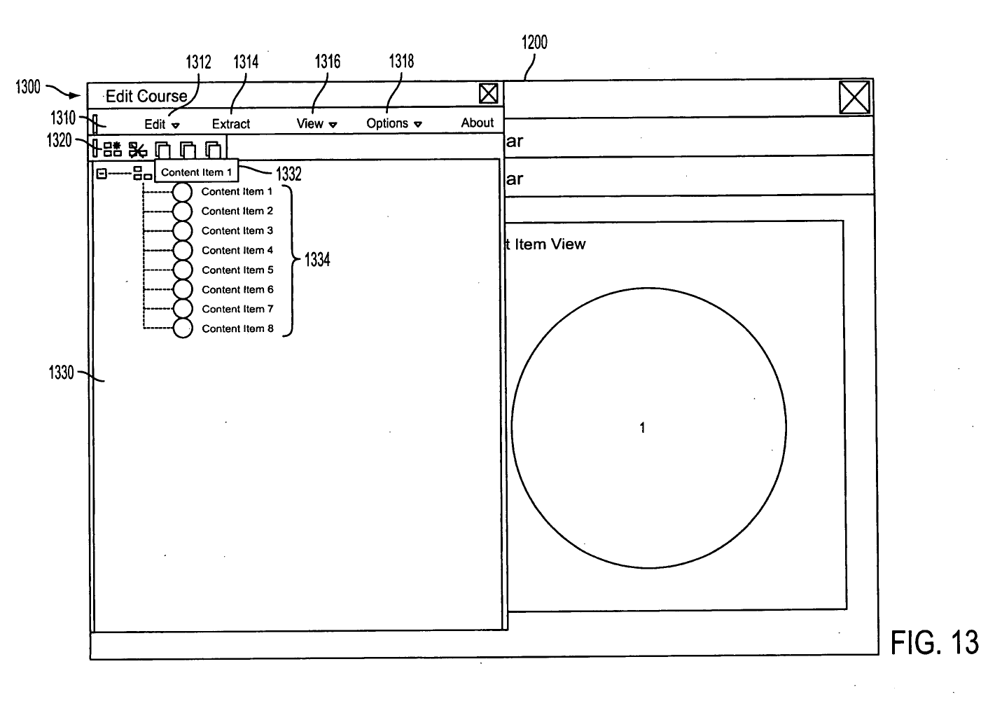

Referring to FIG. 13, the edit course button 1254 may be selected to invoke an edit course window 1300 that allows a user to create an initial course structure from the content items of the presentation. The edit course window 1300 includes a menu bar 1310, a button bar 1320, and a tree view 1330. The menu bar 1310 includes various drop-down menus and virtual buttons, such as, for example, an edit menu 1312, an extract button 1314, a view menu 1316, and an options menu 1318. The button bar 1320 includes a number of virtual buttons. The virtual buttons may be shortcuts to functions in the drop down menus that are used frequently and are active tools for use with the edit course window 1300.

When the edit course window 1300 is opened for a presentation for the first time, the tree view 1330 depicts an initial course structure based on the set of content items of the presentation. The initial course structure may be composed of one learning object 1332 that contains one or more knowledge items 1334 corresponding to the content items of the presentation. The title of the learning object 1332 may be the title or label of the first content item in the set (e.g. title of the presentation). The titles of the knowledge items 1334 may be the titles or labels of the corresponding content items (e.g. heading of each slide in the presentation). The course extractor 795 also may optionally generate a descriptor that relates to a type of content item (e.g., “Slide,” “Video,” “Audio,” or “Content Item”) and may insert the descriptor before the title or label of the corresponding learning objects and knowledge items (e.g., “Slide x,” “Video x,” or “Content Item x” where x is the title or label of the video clip or slide, respectively). In other implementations, the titles of the knowledge items may be created from other attributes or metadata related to the content item (e.g., the time-stamp of the content item and/or the type/category of the content item).

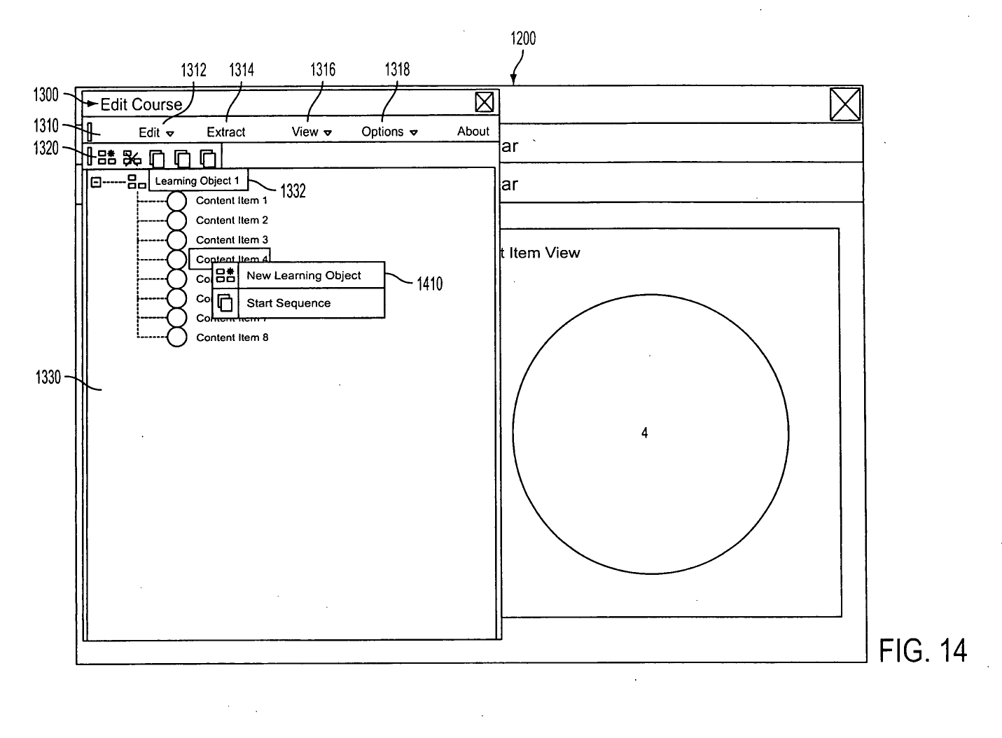

As shown in FIG. 14, the title of the learning object 1332 may be edited by selecting the learning object 1332 and selecting a “rename” command. The “rename” command may be accessed from various inputs associated with the edit course window 1300, such as the edit menu 1312, a pop-up menu (not shown), the button bar 1320, by double-clicking on the text of the title, or by pressing a function key or equivalent. In the example shown, the title of the learning object 1332 was changed from “Content Item 1” to “Learning Object 1.” The titles of the knowledge items 1334 and sequence knowledge items 1710 (discussed below) may be changed in a similar manner.

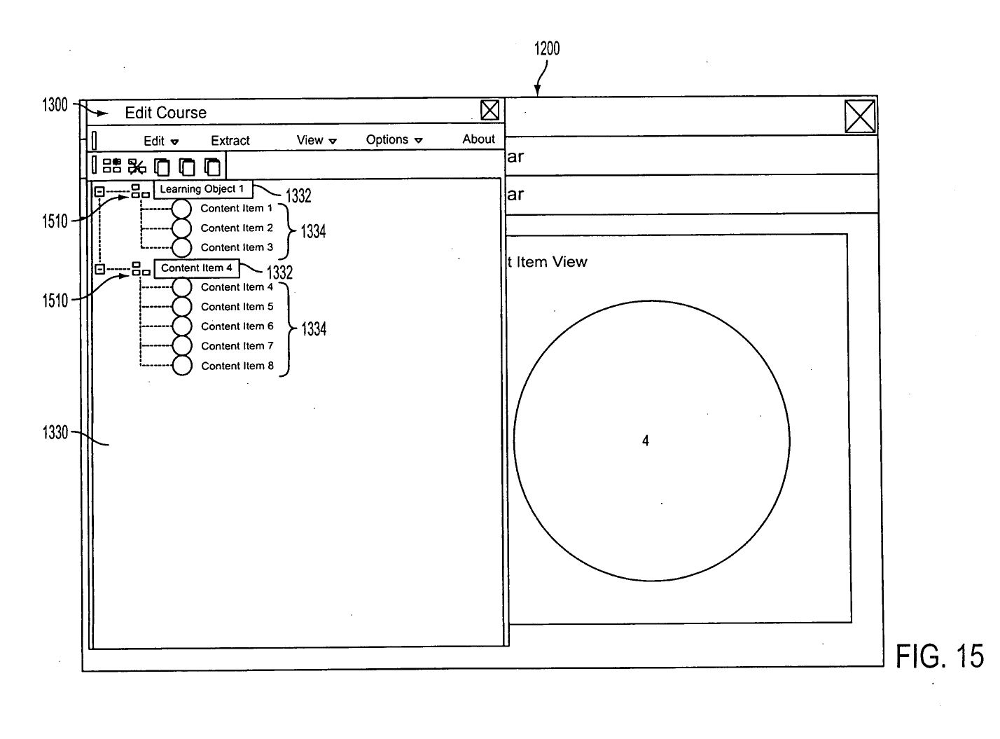

The course structure may be modified by inserting new learning objects. A new learning object 1332 may be created by selecting a knowledge item 1334 and selecting a “new learning object” command. The “new learning object” command may be accessed from the edit menu 1312, from a pop-up menu 1410 (as shown in FIG. 14), from the button bar 1320, or by pressing a function key or equivalent. A new learning object with the title “Content Item 4” (i.e., the same title as the selected knowledge item 1334) may be created as shown in FIG. 15. [0120] Learning objects 1332 may be graphically distinguished from knowledge items 1334 in the tree view 1330 through indentation and/or through the use of a graphical symbol. For example, FIG. 15 shows learning objects 1332 set apart from knowledge items 1334 through both indentation and use of a learning object icon 1510. As shown, the course structure includes two learning objects 1332 and eight knowledge items 1334. The first learning object is “Learning Object 1” and is associated with knowledge items “Content Item 1,” “Content Item 2,” and “Content Item 3.” The second learning object is “Content Item 4” and is associated with knowledge items “Content Item 4,” “Content Item 5,” “Content Item 6,” “Content Item 7,” and “Content Item 8.”

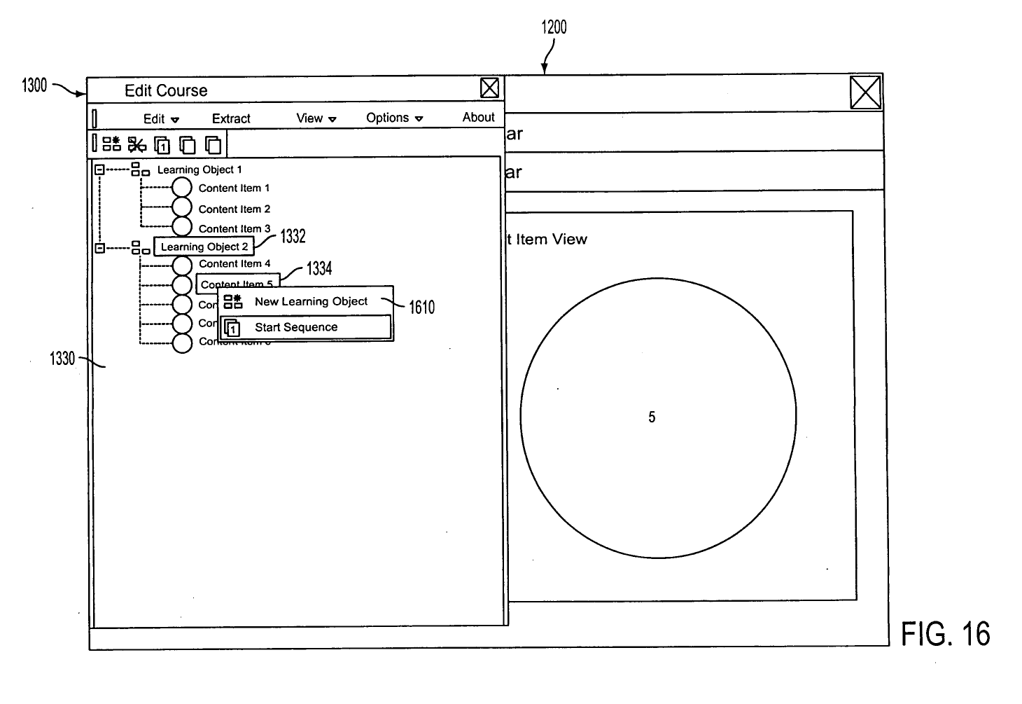

The course structure may be further modified by creating knowledge items 1334 that include a sequence of content items. A new knowledge item including a sequence of content items may be created by selecting a knowledge item 1334 and selecting a “start new sequence” command. The “start new sequence” command may be accessed from the edit menu 1312, from a pop-up menu 1610 (as shown in FIG. 16), from the button bar 1320, or by pressing a function key or equivalent.

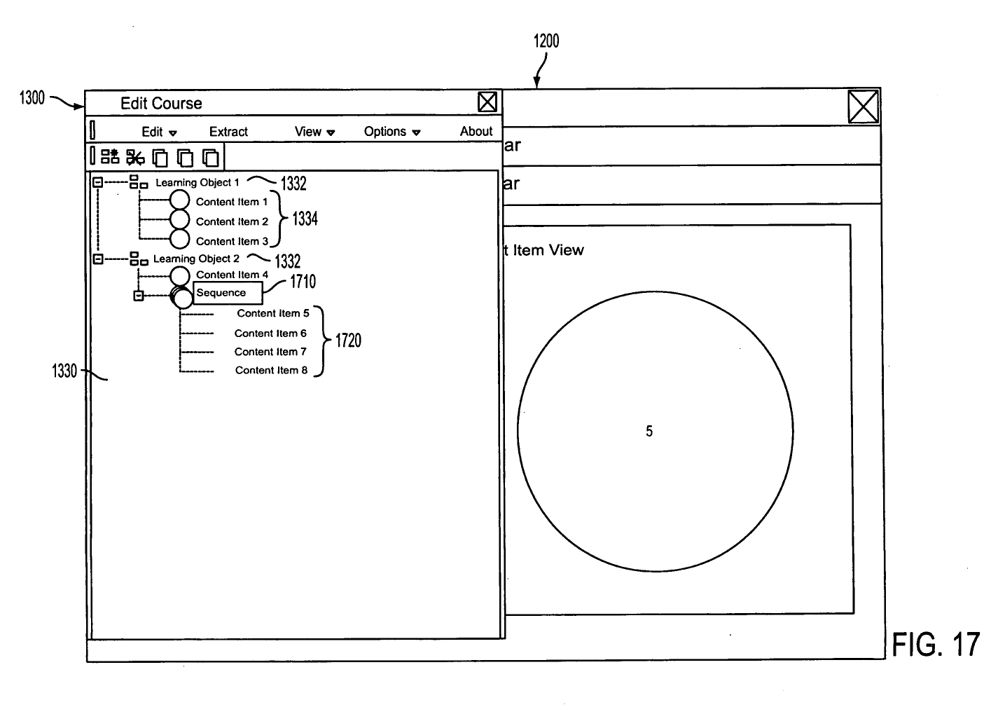

An example of a newly created knowledge item 1710 including a sequence is shown in FIG. 17. The knowledge item 1710 may be given a default title (e.g., the title “sequence” and/or the title of the selected knowledge item) that may be subsequently edited using the “rename” command, as described previously.

Once created, the sequence knowledge item 1710 includes the content item corresponding to the selected knowledge item 1334 and the subsequent content items 1720 corresponding to the (previously labeled) knowledge items 1334 in the same learning object 1332 as the selected knowledge item 1334. The content items in the sequence knowledge item 1710 correspond to one knowledge item (i.e., the sequence knowledge item 1710 and not to the individual knowledge items 1334).

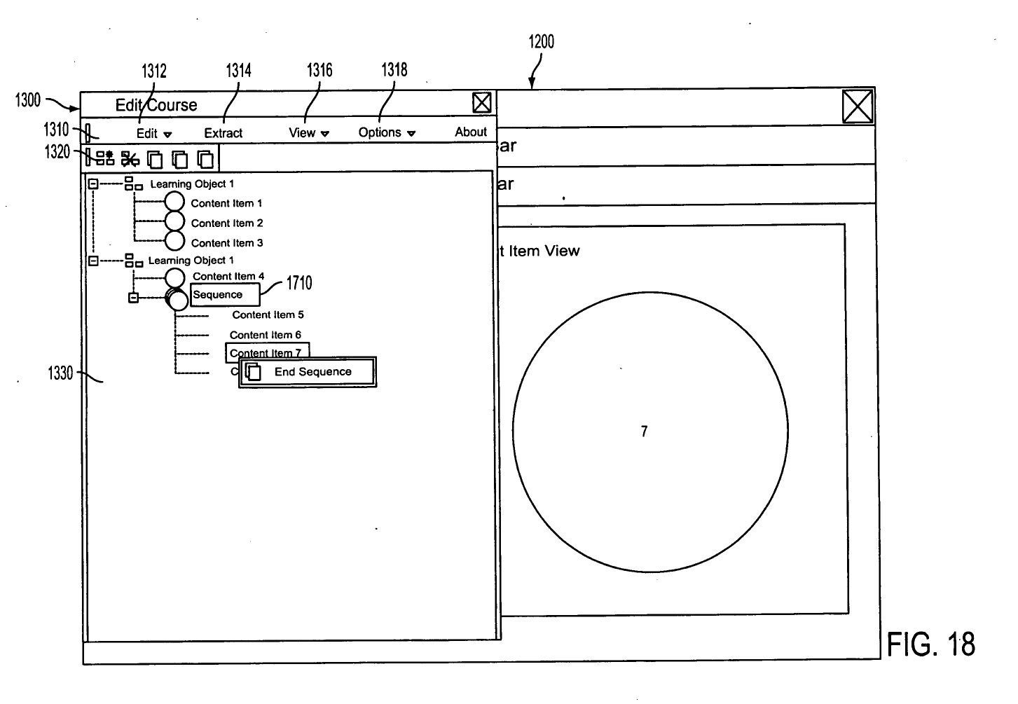

An “end sequence command” may be accessed to designate the end of the sequence of the content items contained in the sequence knowledge item 1710. The “end sequence command” may be accessed from the edit menu 1312, from a pop-up menu (as shown in FIG. 18), from the button bar 1320, or by pressing a function key or equivalent.

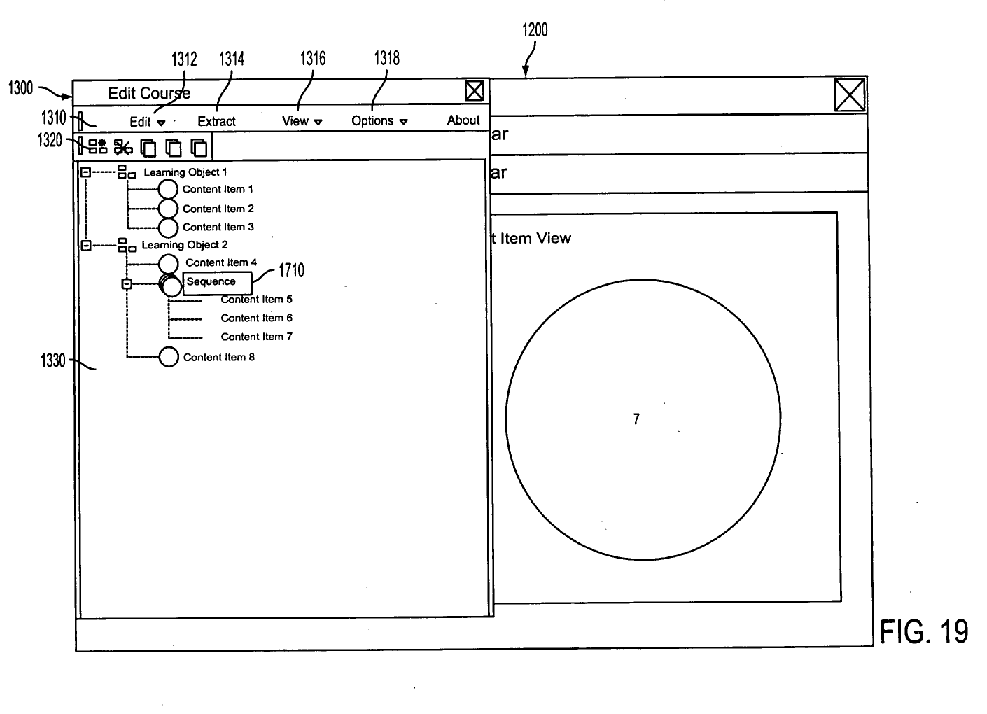

FIG. 19 shows the sequence knowledge item 1710 that results from using the “end sequence command” as shown in FIG. 18. If the learning object 1332 containing the selected knowledge item 1334 only includes the selected knowledge item 1334 (i.e., the learning object 1332 contains only one knowledge item 1334), then the “start new sequence command” and the “end sequence command” are unavailable. Alternatively, a sequence may be created by selecting a knowledge item 1334 and one or more subsequent knowledge items 1334 that belong to the sequence and selecting a “create sequence command.” The “create sequence” command may be accessed from the edit menu 1312, from a pop-up menu, from the button bar 1320, or by pressing a function key or equivalent. Sequence knowledge items 1710 may be advantageously used, for example, to create animations from a series of static graphical content items (e.g., a sequence of slides may be used to create an animation).

The techniques described to create learning objects 1332 and sequence knowledge items 1710 may be more generally applied to create other structural elements. For example, a “new sub course command” may be accessed to create sub courses consisting of learning objects 1332, sequence knowledge items 1710, and/or knowledge items 1334. The “new sub course command” may function in a similar fashion as the “new learning object command.” Sub courses may be graphically distinguished from both learning objects 1332, sequence knowledge items 1710, and knowledge items 1334 in the tree view 1330 through indentation and/or through the use of a graphical symbol.

Once the course structure has been established the extract course button 1314 may be selected to extract the course corresponding to the structure displayed in the tree view 1330. The extraction process creates course structure files that are compatible with the course editor 780 and the content player 720. The content items may be extracted into media files in a format that may be specified using the options menu 1256 or the options menu 1318. The format of the media files typically corresponds to the formats supported by the presentation tool 790 but may be modified for interpretation by the course editor 780 and the content player 720. The media files and course structure files also may be stored in a manner that is compatible with the course editor 780. For example, all files associated with a learning object may be stored inside a single directory, and files belonging to different learning objects may be stored in different directories. All of the learning object directories may themselves be stored in a single directory corresponding to the course. The course structure depicted in FIG. 19, therefore, may be extracted into a directory named “example” (i.e., the course title is “example”) that includes a course structure file “example.crs” and two directories named “Learning_Object_{—}1” and “Learning_Object_{—}2” (i.e., corresponding to the titles of the learning objects). Each learning object directory may include a course structure file and one or more media files corresponding to the knowledge items depicted in FIG. 19 associated with the learning object.

The view menu 1316 in the menu bar 1310 may be accessed to select an option that modifies the way that a content item is viewed when a knowledge item corresponding to the content item is selected in the tree view 1330. For example, the view menu 1316 may include an option to display a miniature graphic of the content item upon selection of the corresponding knowledge item (e.g., a miniature of a slide). The view menu 1316 also may include an option to synchronize the content item view 1240 with the tree view 1330 such that the content item view 1240 displays the content item associated with the knowledge item that is currently selected in the tree view 1330.

The options drop down menu 1318 includes options that relate to and modify the extraction process, such as, for example, an option to specify the preferred media file format used for extraction and an option to use portions or attributes of the content items as annotations to or attributes of corresponding knowledge items. The options drop down menu 1318 may include the same or different options as the options drop down menu 1256.

The course structure created using the edit course window 1300 may be stored along with associated presentation-related data when a user saves a presentation. When a user closes and reopens the presentation tool interface 1200, the course structure created using the edit course window 1300 may be further edited. When the set of content items of the presentation is modified through creation of new content items or deletion of content items, the extractor 795 automatically adapts (i.e., updates) the course structure to correspond to the modified set of content items. For example, referring to FIG. 19, if a new content item is placed between “Content Item 3” and “Content Item 4,” the new content item may be automatically placed within “Learning Object 1”. If a new content item is placed between “Content Item 5” and “Content Item 6,” the new content item may be automatically placed in the sequence knowledge item “Sequence”. If “Content Item 1”, “Content Item 2”, and “Content Item 3” are deleted, then “Learning Object 1” may be automatically removed from the course structure. If “Content Item 5” and “Content Item 7” are deleted, then the sequence knowledge item “Sequence” may be automatically removed from the course structure and may be replaced by a knowledge item titled “Content Item 6.”

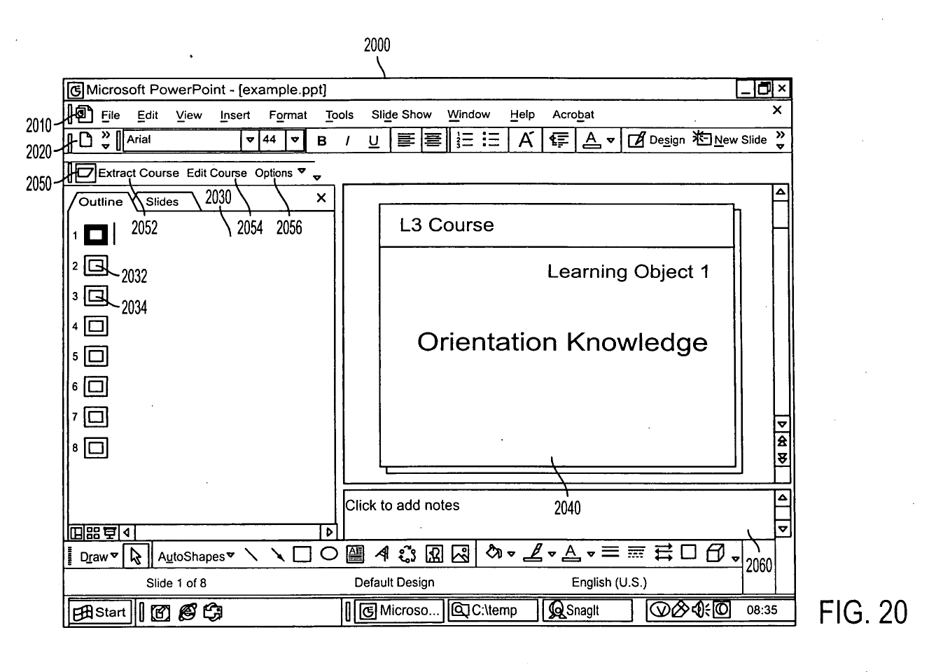

FIG. 20 shows another presentation tool interface 2000 (similar to presentation tool interface 1200) corresponding to a presentation tool 790 that includes Microsoft® PowerPoint®. The course extractor 795 is a software add-on or plug-in to Microsoft® PowerPoint®. In this implementation, the presentations created, modified, saved, and deleted using the presentation tool 790 include a set of slides that may be used, for example, in a slide show presentation (i.e., the content items are slides). The slides may consist of text, tables, pictures, graphics, audio clips, video clips, animations, and/or any combination thereof.

The presentation tool interface 2000 includes a menu bar 2010, a button bar 2020, an outline view 2030, a content item view 2040, and a course extractor bar 2050. The outline view 2030 shows an outline of the slide show presentation. The outline includes a set of slide symbols 2032 arranged in sequential order. The course extractor bar 2050 includes an extract course button 2052, an edit course button 2054, and a drop down options menu 2056. Examples of each element within the interface 2000 of FIG. 20 are described broadly above with respect to FIG. 12. In particular, the menu bar 2010, the button bar 2020, the outline view 2030, the content item view 2040, and the course extractor bar 2050 have attributes and function in manner similar to those described with respect to the menu bar 1210, the button bar 1220, the outline view 1230, the content item view 1240, and the course extractor bar 1250. Likewise, the symbols 2032, the extract course button 2052, the edit course button 2054, and the options drop down menu 2056 are similar to those described for the symbols 1232, the extract course button 1252, the edit course button 1254, and the options drop down menu 1256 of FIG. 12.

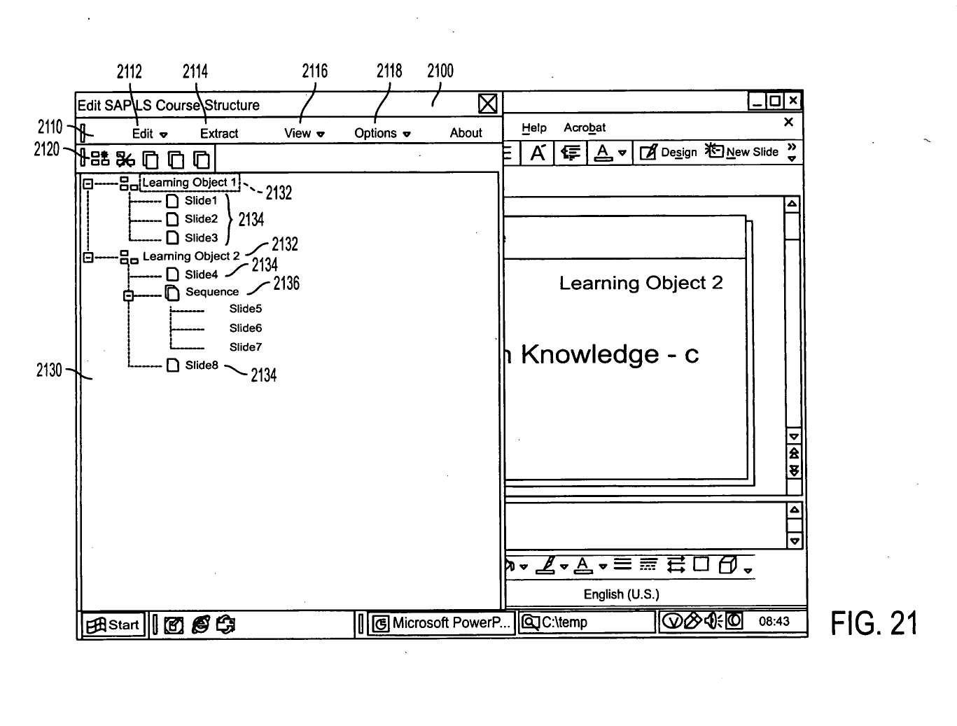

FIG. 21 shows another edit course window 2100 (similar to edit course window 1300) corresponding to the presentation tool interface 2000. The edit course window 2100 includes a menu bar 2110, a button bar 2120, and a tree view 2130. The menu bar 2110 includes various drop-down menus and buttons, such as, for example, an edit menu 2112, an extract button 2114, a view menu 2116, and an options menu 2118. The tree view 2130 includes learning objects 2132, knowledge items 2134, and sequence knowledge items 2136. Examples of each element within the edit course window 2100 are described broadly above with respect to FIG. 13.

In particular, the menu bar 2110, the button bar 2120, and the tree view 2130 typically have attributes comparable to those described with respect to the menu bar 1310, the button bar 1320, and the tree view 1330. Likewise, the edit menu 2112, the extract button 2114, the view menu 2116, the options menu 2118, the learning objects 2132, the knowledge items 2134, and the sequence knowledge item 2136 are similar to those described for the edit menu 1312, the extract button 1314, the view menu 1316, the options menu 1318, the learning objects 1332, and the knowledge items 1334 of FIG. 13 and the sequence knowledge item 1710 of FIG. 17, respectively.

The view menu 2116 may include an option to show a slide miniature of a slide corresponding to a selected knowledge item 2134 in the tree view 2130. The view menu 2116 also may include an option to synchronize the slide window (i.e., the content item window 2040) with the tree view 2130 such that the slide window always displays a slide corresponding to a selected knowledge item 2134 in the tree view 2130.

The options menu 2118 may include an option to extract the slides (i.e., the media files) using PPS format (i.e., Microsoft® PowerPoint® format) rather than the default HTML format. The options menu 2118 also may include an option to extract slide notes (which may be inputted in window 2060 of FIG. 20 for a selected slide) as annotations to the knowledge items corresponding to the slides. The options menu 2118 may further include an option to extract slide images for use as thumbnails for the knowledge items by invoking the ability of Microsoft® PowerPoint® to generate a Joint Photographic Experts Group (JPEG) image of each slide.

A course may be extracted by selecting the extract course button 2052 or the extract button 2114. The extraction process includes saving the slideshow as a PPS or HTML slideshow file, modifying the PPS or HTML slideshow file to make it compatible with the course editor 780 and the content player 720, segmenting the PPS or HTML slideshow file into PPS or HTML media files, and saving the media files along with associated course structure files in the appropriate directories. For example, when saving HTML slide show files, Microsoft® PowerPoint(® typically saves two versions of the slides. The first version includes the slides separated into frames and also includes navigation data. The second version only includes the slides separated into frames. The extraction process may include, for example, discarding the first version of the HTML slide show file (since the course editor 780 provides its own navigation) and modifying the second version. The modification of the second version may include, for example, elimination of the black page with the text “End of slide show, click to exit” that is typically included by Microsoft® PowerPoint® at the end of each slide show. The modification may further include changing the color of the background of the slides (e.g., from black to white) and bug fixes in the HTML format generated by PowerPoint®.

The extraction process may save the slides as PPS or HTML media files by segmenting the modified HTML or PPS slide show file into multiple HTML or PPS media files, each media file corresponding to one knowledge item (i.e., to one slide or to a sequence of slides). The multiple HTML or PPS media files may be stored in directories corresponding to the learning objects that contain the knowledge items. For example, in FIG. 21, three HTML or PPS media files titled “Slide1,” “Slide2,” and “Slide3” 2134 may be created and stored along with a learning object structure file for Learning Object 1 2132 in a directory named “Learning_Object_{—}1.”Similarly, three HTML or PPS media files titled “Slide4,” “Sequence,” and “Slide8” may be created and stored along with a learning object structure file for Learning Object 2 in a directory named “Learning_Object_{—}2.” The HTML or PPS media file titled “Sequence” includes HTML-formatted data corresponding to “Slide5,” “Slide6,” and “Slide7.’ The directories named “Learning_Object_{—}1” and “Learning_Object_{—}2” may be stored along with a course structure file in a course directory named “example.”

The course structure, as displayed in the tree view 2130, also may be stored along with the slide show data in the HTML or PPS slide show file itself. Saving the course structure in the HTML or PPS slide show file preserves the course structure and makes the course structure available when the slide show presentation is closed and subsequently reopened for further modification using the presentation tool 790. When a user saves the slide show presentation by accessing, for example, a “save” command in a file menu in the menu bar 2010, the course structure may be stored within the HTML or PPS slide show file using the key-value mechanism of Microsoft® PowerPoint®.

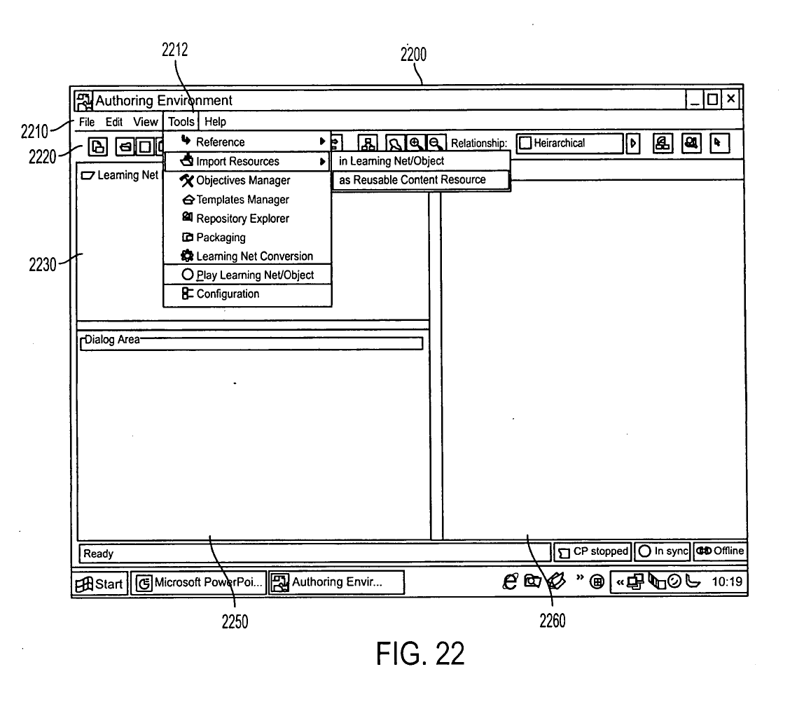

Once the course structure and media files are created through the extraction process, the course structure may be imported into the course editor 780 for subsequent refinement and modification. FIG. 22 shows an implementation 2200 of the course editor interface 800 that may be used to import the course structure and media files generated by the course extractor 795. The course interface 2200 includes a menu bar 2210, a button bar 2220, a course overview 2230, a dialog box 2250, and a work space 2260. Examples of each element within the course editor interface 2200 are described broadly above with respect to FIG. 8. In particular, the menu bar 2210, the button bar 2220, the course overview 2230, the dialog box 2250, and the work space 2260 have attributes comparable to those described with respect to the menu bar 810, the button bar 820, the course overview 830, the dialog box 850, and the work space 860.

The menu bar 2210 may include a tools drop down menu 2212 that allows a user to access resource management functions. The resource management functions accessible from the tools menu 2212 may include functions related to resource configuration, resource importation, resource packaging, and resource conversion. As shown in FIG. 22, the Tools menu 2212 includes an Import Resources sub menu that, in turn, includes a command to import a resource “as (a) Reusable Content Resource.” The “Reusable Content Resource” command may be used to store the course structure files and media files created by the course extractor 795 content repository. The content repository is a storage location configured to store content for the course editor 780.

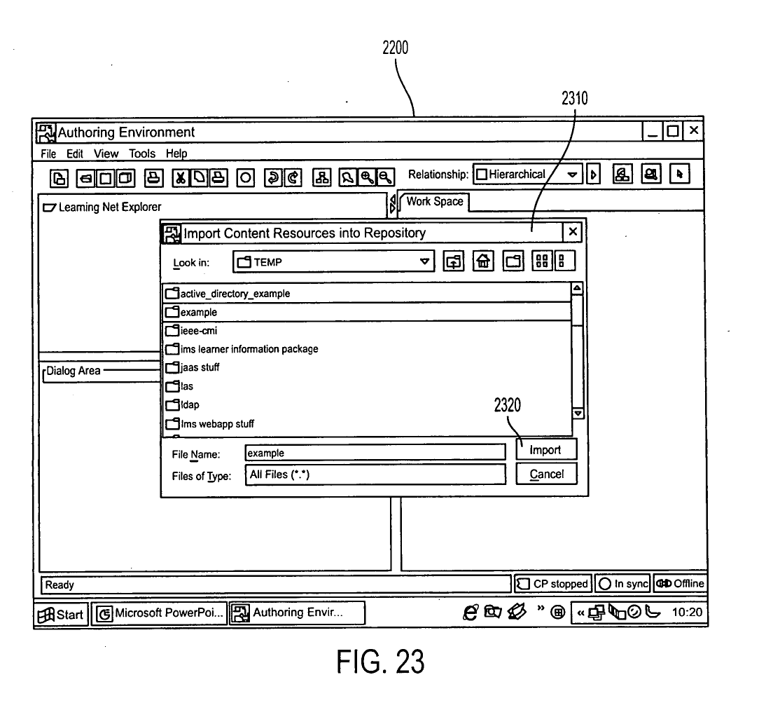

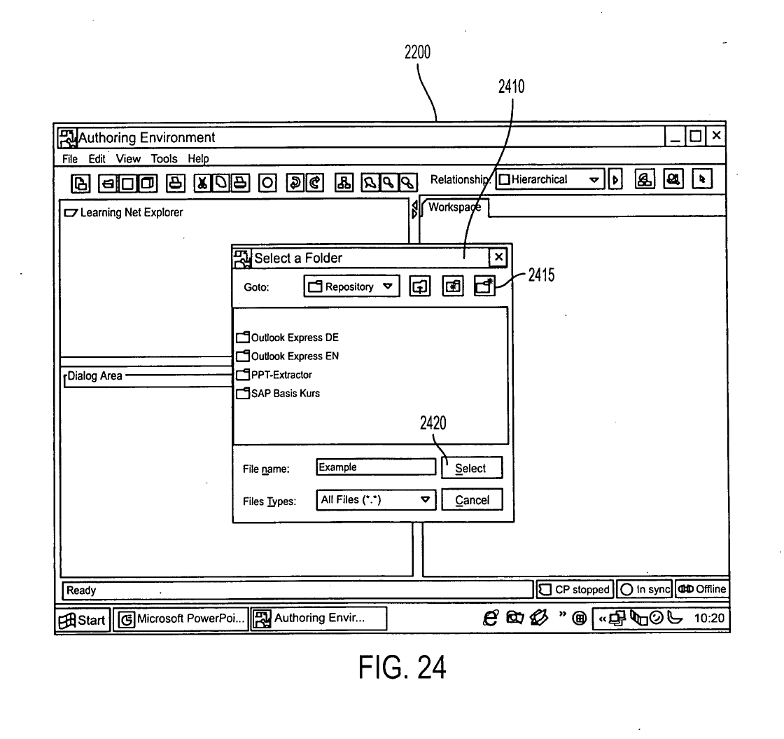

As shown in FIG. 23, selection of the “Reusable Content Resource” command may open an explorer window 2310 that may be used to locate the directory that contains the extracted course structure files and media files. In this example, the directory is named “example” (i.e., the name of the course), and the directory is found in the “Temp” directory. Once the directory is selected in the explorer window 2310, the user may select an “import” button 2320. The explorer window 2310 then closes, and a new explorer window 2410 opens as shown in FIG. 24. The new explorer window 2410 depicts the contents of the content repository. The content repository may be a local folder in which course content is stored for subsequent access by the course editor 780.

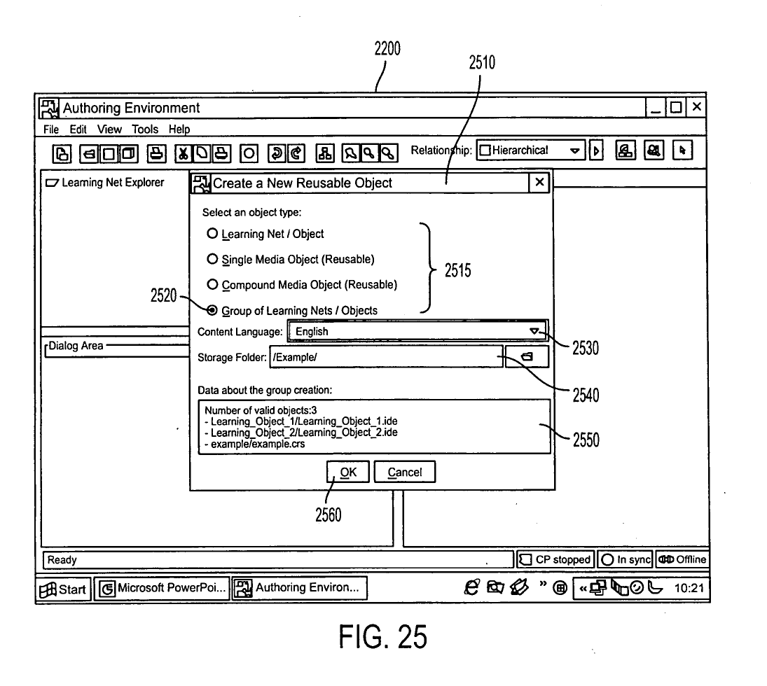

In the example shown in FIG. 24, the content repository folder contains four courses (or sub-courses) stored in four separate directories: “Outlook Express DE,” “Outlook Express EN,” “PPT-Extractor,” and “SAP Basis Kurs.” The extracted course structure and media files may be stored in a course directory named “example” in the content repository folder. The course directory named “example” may be created by selecting a create folder button 2415 and inputting the name “example.” The extracted course structure and media files may then be stored in the course directory named “example” by selecting the newly created course directory named “example” in the explorer window 2410 and then selecting a “select” button 2420. Upon selection of the “select” button 2420, the explorer window 2410 closes and a “create a reusable content object” window 2510 is opened as shown in FIG. 25.

The “create a reusable content object” window 2510 may include a list of object types 2515, a content language entry 2530, a storage folder entry 2540, and a display area 2550 to display data related to the object(s) being imported. A user specifies the type of content that will be stored in the content repository by choosing from among the list of object types 2515. The extracted course structure and media files typically correspond to a group of learning objects. Therefore, the user selects the “Group of Learning Nets/Objects” option 2520 from the list of available object types 2515. After selecting the type of object (e.g., “Group of Learning Nets/Objects”), the content language (e.g., “English”), and the storage folder (e.g., “/example/”), the user may confirm the choices by selecting, for example, an “OK” button 2560. Upon selection of the “OK” button 2560, the window 2520 closes and the extracted course structure and media files are imported into the specified course directory in the content repository folder and are subsequently considered a group of learning objects by the course editor 780.

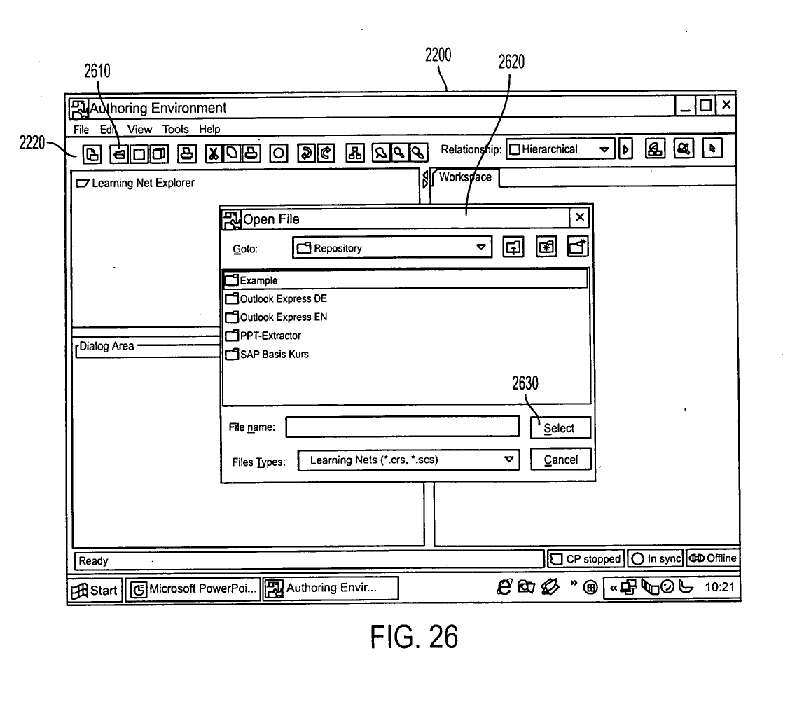

Referring to FIG. 26, the imported course structure and media files may then be opened, for example, by selecting an open button 2610 on the button bar 2220. An “open file” explorer window 2620 may be opened upon selection of the open button 2610, and the user may then open the imported course structure and media files by selecting the course directory (e.g., the “example” directory) followed by the “select” button 2630 in the window 2620.

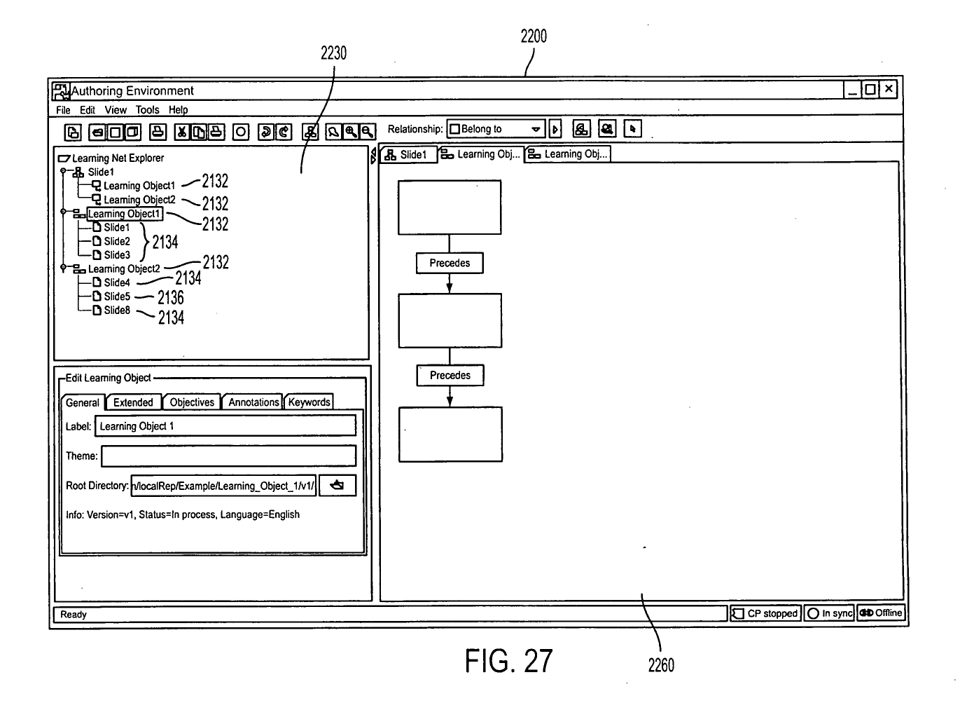

FIG. 27 shows the course editor interface 2200 when the imported course structure and media files are opened. The course structure is depicted in the course overview 2230 and corresponds to the course structure shown in the tree view 2130 of the edit course window 2100 (with the exception that the title of the sequence knowledge item is shown in FIG. 27 as “Slide5” rather than “Sequence”). Because the learning objects 2132, the knowledge items 2134, and the sequence knowledge items 2136 are ordered sequentially in the edit course window 2100, the relations between the structural elements shown in the work space 2260 are “Precedes.” The course editor 280 may now be used to refine and modify the imported course structure.

Modification and refinement of the imported course structure may include changing the relations between the structural elements, adding/deleting structural elements, and modifying the contents of the structural elements. Modification of the contents of the structural elements may include editing the contents of the knowledge items in the course. The course editor 780 may be configured to associate a knowledge item with an application or tool that may be used to view or edit the contents of the knowledge item. The user may use the browser window 2250 of the course editor interface 2200 to select, to view, or edit the contents of a knowledge item. In response to such a selection, the course editor 780 may automatically open a media file corresponding to the contents of the knowledge item by launching an application (e.g., Microsoft® PowerPoint®) able to view and/or edit the media file.

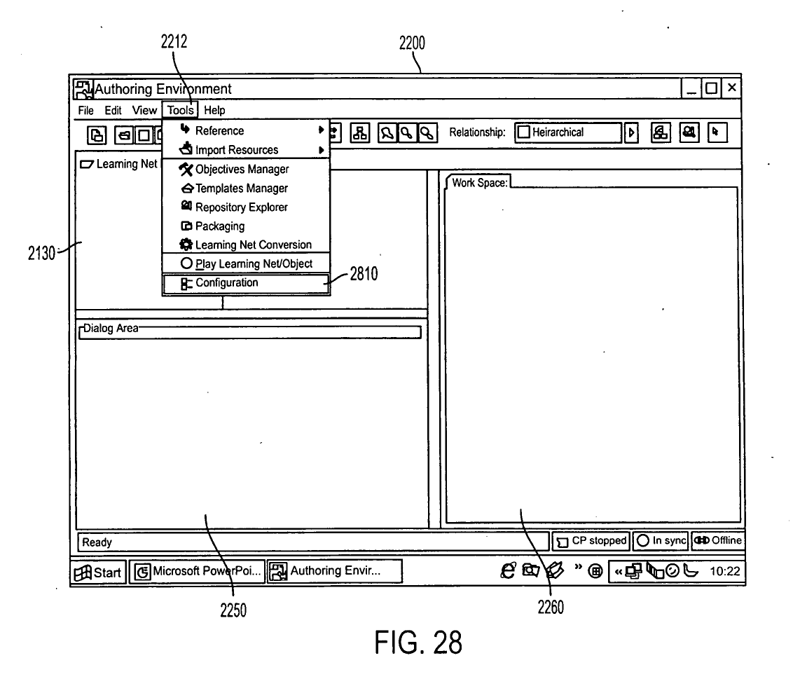

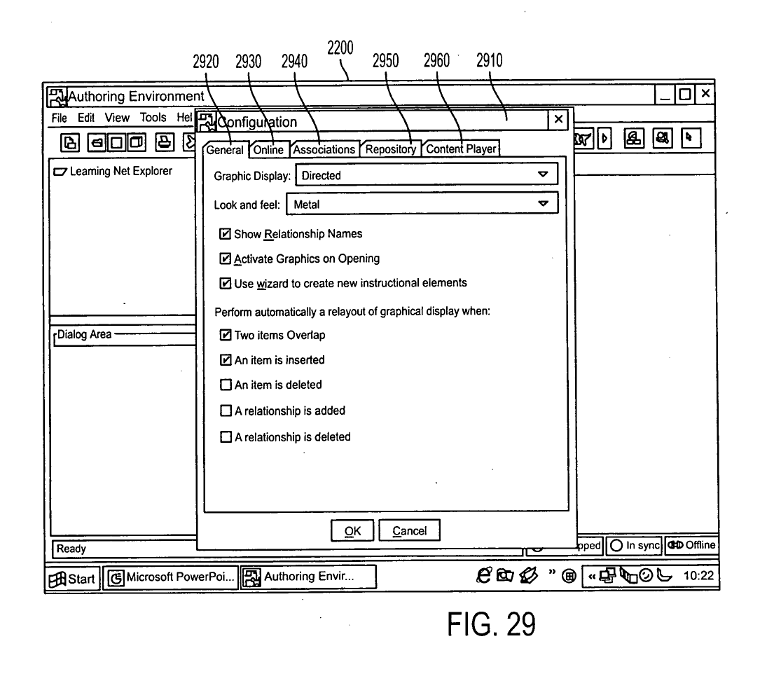

Referring to FIG. 28, the Tools menu 2212 includes a configuration command 2810 that may be used to set up an association between a media type and an application used to view or edit the contents of the knowledge item. As shown in FIG. 29, selection of the configuration command 2810 may open a configuration window 2910 that may be used to configure the resources available to the course editor 780. The configuration window 2910 may include a general tab 2920, an online tab 2930, an associations tab 2940, a repository tab 2950, and a content player tab 2960. The general tab 2920 may be used to set general resource configuration settings related to the display of resources in the course editor interface 2200. The online tab 2930 may be used to configure resource access via a network. The associations tab 2940 may be used to associate resources with specific applications or tools. The repository tab 2950 may be used to set storage settings related to the content repository. The content player tab 2960 may be used to configure the communications between the course editor 780 and the content player 720.

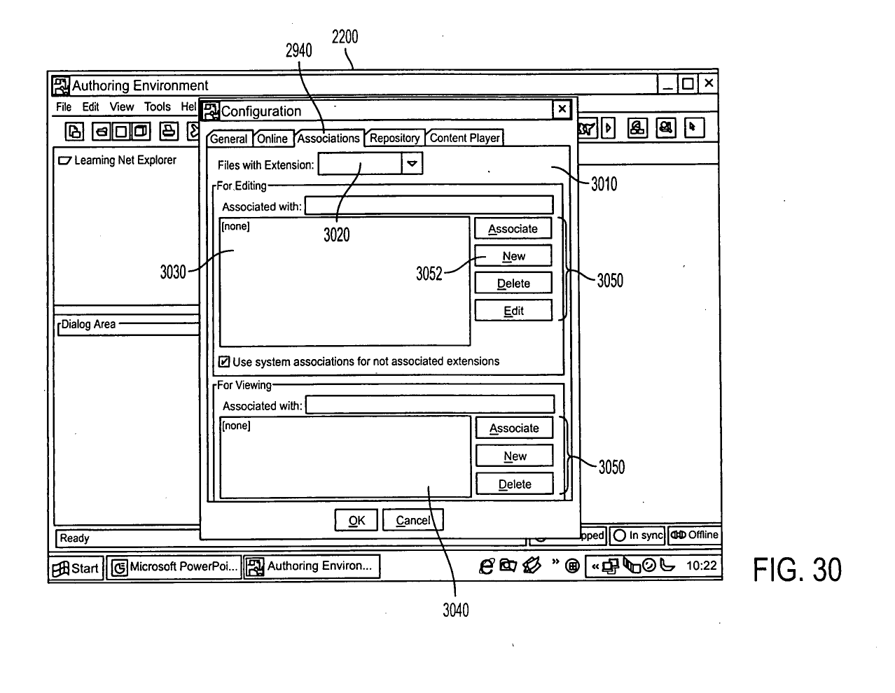

Referring to FIG. 30, selection of the associations tab 2940 allows access to an associations interface 3010. The associations interface 3010 includes a file extension entry 3020, an associations display 3030 for editing, an associations display 3040 for viewing, and a set of buttons 3050 used to create, edit, and delete associations. A knowledge item is typically associated with a media file that is stored using a file extension. Media files stored with the same file extension may be associated with a particular application or tool able to view or edit the media files. The associations interface 3010 may be used to select a file extension by inputting the extension in the file extension entry 3020 or by selecting the extension from a drop down menu. When a file extension is selected, displays 3030 and 3040 may show all associations related to that file extension. If no file extension is selected in the file extension entry 3020, displays 3030 and 3040 may show all associations currently in use by the course editor 780.

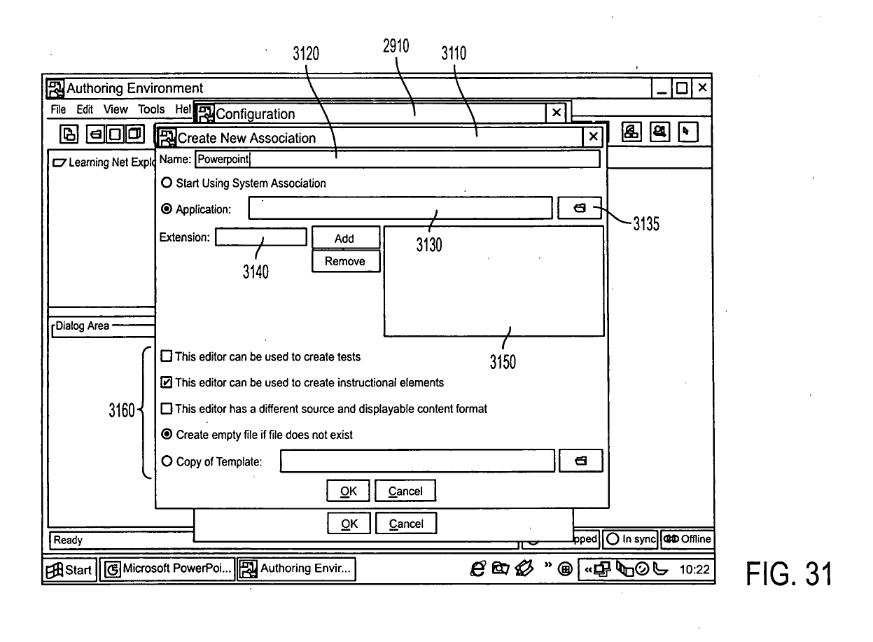

A new association may be created by selecting a “New” button 3052. Selecting the “New” button 3052 opens a create new association window 3110 as shown in FIG. 31. The create new association window 3110 includes a name entry 3120, an application entry 3130, an extension entry 3140, an extension display 3150, and editor configuration settings 3160. A name may be assigned to the association (e.g., PowerPoint®) by inputting a name into the name entry 3120. The name may be, for example, the name of an editor application that may be used to edit any media files that have file extensions shown in the extension display 3150. The command that may be used to launch the editor application is inputted in the application entry 3130. The extension entry 3140 may be used to input file extensions associated with the editor application specified in the application entry 3130. All file extensions associated with the specified editor application are shown in display 3150. The editor configuration settings 3160 may be used to specify the function and characteristics of the editor application. For example, the editor configuration settings 3160 may include a setting that specifies that the editor may be used to create tests and/or that the editor may be used to create the content of knowledge items (i.e., media files). The editor configuration settings 3160 may further include a setting that specifies that the editor may create an empty file if the media file with the associated file extension selected for editing does not yet exist. Rather than creating an empty file, the editor configuration settings 3160 also may provide for creation of a file from an already existing template by specifying the location of the template.

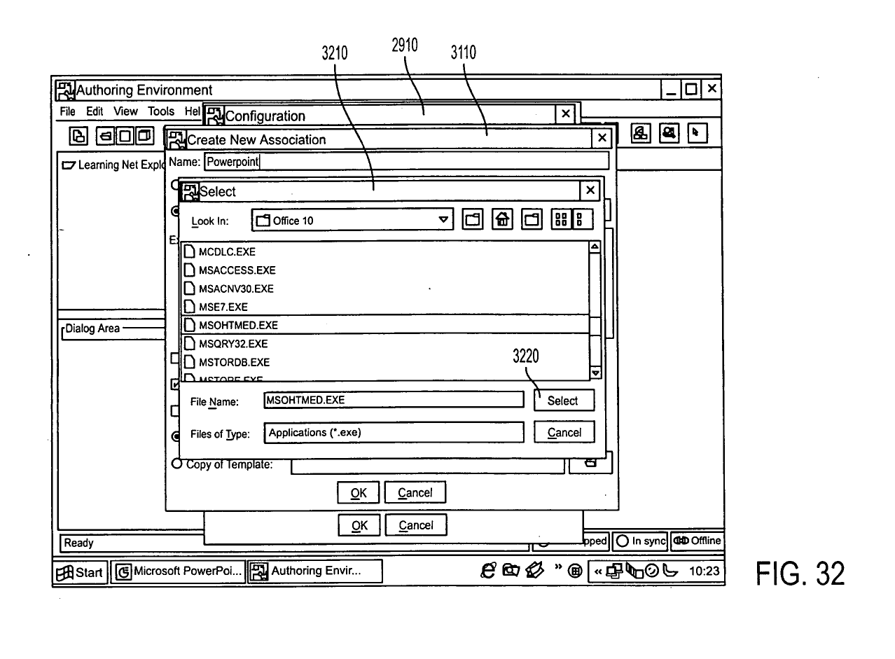

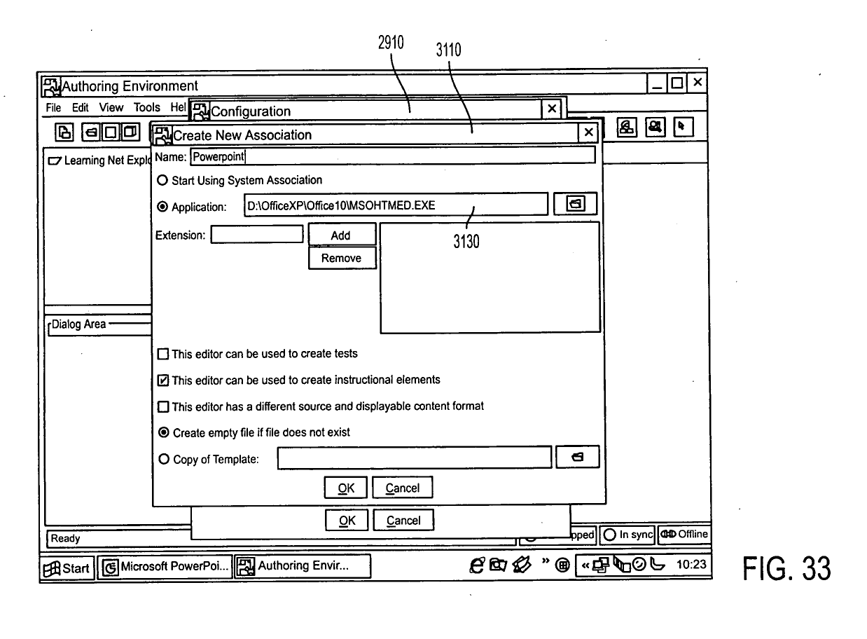

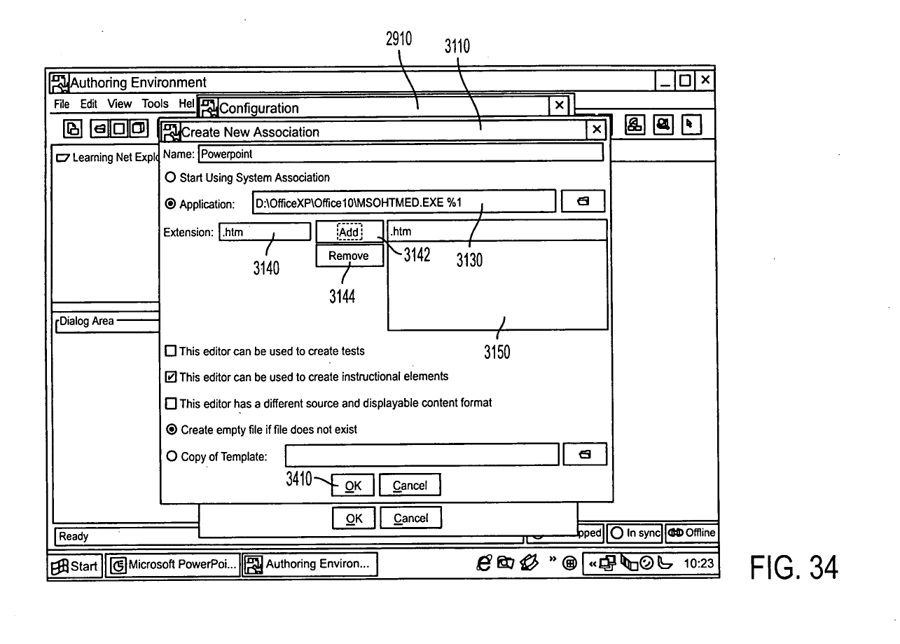

The user may specify the command used for launching the editor application by either inputting the command directly into the application entry 3130 or selecting a browse button 3135 next to the application entry 3130. Referring to FIG. 32, selection of the browse button 3135 opens an explorer window 3210 that may be used to find and select the executable file of the editor application. The user may confirm the choice by selecting the “Select” button 3220. In the example shown in FIG. 32, the executable file is named “MSOHTMED.EXE” and the corresponding editor application is Microsoft® PowerPoint®. Upon selection of the “Select” button 3220, the explorer window 3210 closes, and the command to launch the executable file appears automatically in the application entry 3130 as depicted in FIG. 33. The command as depicted in the application entry 3130 may be used to launch the editor application. However, the command may be modified by the user to allow the associated media file to be automatically opened when the editor application launches. As shown in FIG. 34, the command may be modified to open the associated media file, for example, by appending a “% 1” or similar placeholder for the name of the media file to the end of the command.

The user may specify a file extension associated with the editor application by inputting the file extension into the extension entry 3140 and selecting an “add” button 3142. After inputting the file extension and selecting the “add” button 3142, the added extension may be depicted in the extension display 3150. Any extensions depicted in the extension display 3150 may be removed (and, thus, no longer associated with the editor application) by selecting a “remove” button 3144. The user may complete the creation of the new association, for example, by selecting an “OK” button 3410.

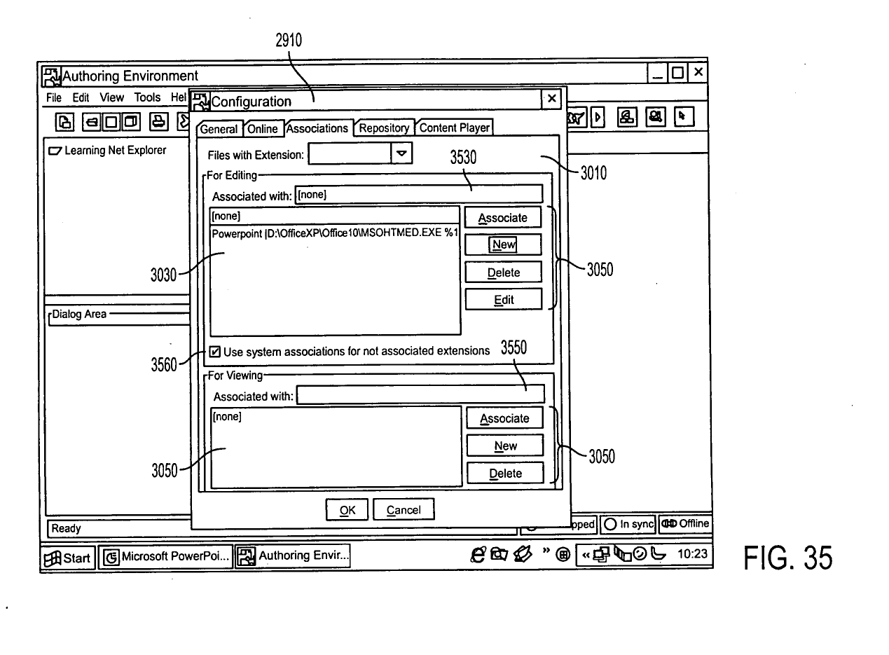

Upon selection of the “OK” button 3410, the create new association window 3110 may close and the associations interface 3010 may now show the newly created association in the associations display 3030 as shown in FIG. 35. The newly created association may be listed by the name of the association and/or by the command used to launch the associated application. In the example shown in FIG. 35, the newly created association for editing is listed as “PowerPoint® [D:\OfficeXP\Office10\MSOHTMED.EXE %1].” Creation of associations used for viewing media files may be accomplished in a manner corresponding to that discussed above for creating associations for editing media files.

A user may modify and delete associations listed in the displays 3030 (for editing) and 3050 (for viewing) by selecting one of the associations listed in the respective display and selecting a corresponding button from the set of buttons 3050. When an association is selected in the display 3030 or in the display 3050, a corresponding “associated with” display 3530 or 3550 may show the extensions related to the selected association. For example, selecting the newly created association listed as “PowerPoint® [D:\OfficeXP\Office10\MSOHTMED.EXE%1]” results in the extension “.html” appearing in the “associated with” display 3530. Other extensions that may be added to an association and may appear in the displays 3530 or 3550 may include, for example, “.PPS,” “.mp3,” “doc,” “.MPEG,” “.JPEG,” “.JSP,” “wav,” and “.dbs.”

A user may select a “use system associations” check box 3560 to set a default association for any media files with extensions not included in any association. Accordingly, editing or viewing media files with extensions not included in any association may automatically launch a default application as specified by the course editor 780.

Once a set of associations for various media files is created, a user may use the course editor interface 2200 to edit the contents of selected knowledge items by selecting an edit content option in the dialog box 2250. Upon selection of the edit content option, the course editor 780 determines whether the corresponding media file includes a file extension associated with a particular application. If an association exists for the file extension of the media file, the course editor 780 launches the corresponding editor or viewer application by executing the command specified in the command entry 3130 of the association. For example, when a user selects to edit a media file named “slide1.html”, the course editor 780 looks for an association for the file extension “.html”. The course editor 780 determines that the PowerPoint® association applies to this extension and, therefore, launches the Microsoft® PowerPoint® application by executing the command “D:\OfficeXP\Office10\MSOHTMED.EXE Slide1.html” (where the “%1” in the corresponding command entry 3130 has been replaced by the media file name).

A number of implementations have been described. Nevertheless, it will be understood that various modifications may be made. For example, advantageous results may be achieved if the steps of the disclosed techniques are performed in a different order and/or if components in a disclosed system, architecture, device, or circuit are combined in a different manner and/or replaced or supplemented by other components. Accordingly, other implementations are within the scope of the following claims.

What is claimed is:

1. A method for creating an e-learning course, the method comprising:
receiving from a presentation tool a first set of one or more content items associated with a sequential order;
determining a course structure by associating one or more portions or content items of the first set of content items with course structural elements; and
extracting a course associated with the course structure.

2. The method of claim 1, wherein determining a course structure comprises determining a course structure by grouping one or more portions or content items of the first set of content items with course structural elements.

3. The method of claim 1, wherein extracting the course comprises extracting the course structure for importation into a course author tool.

4. The method of claim 1, wherein the content items comprise one or more types of presentation media.

5. The method of claim 4, wherein the types of presentation media include a text, a table, a graphic, an image, an audio clip, a video clip, and a slide.

6. The method of claim 1, wherein determining a course structure comprises creating a course structure.

7. The method of claim 1, wherein determining a course structure comprises editing a course structure.

8. The method of claim 7, wherein editing a course structure includes grouping a portion of the first set of content items with a learning object.

9. The method of claim 7, wherein editing a course structure includes grouping a portion of the first set of content items with a sequence knowledge item.

10. The method of claim 7, wherein editing a course structure includes grouping a portion of the first set of content items with a sub course.

11. The method of claim 7, wherein editing a course structure includes changing a title of a course structural element.

12. The method of claim 1, wherein extracting the course includes extracting course structure files and media files that correspond to the course.

13. The method of claim 12, wherein extracting the course includes specifying the file format for the media files.

14. The method of claim 12, wherein extracting media files includes extracting media files in a file format supported by the presentation tool and a course author tool.

15. The method of claim 12, wherein extracting the course includes storing the course structure files and media files in a manner that is compatible with a course author tool.

16. The method of claim 15, wherein the course structural elements include learning objects and storing includes storing all files associated with a learning object inside a directory.

17. The method of claim 16, wherein the directory contains a course structure file and one or more media files corresponding to knowledge items associated with the learning object.

18. The method of claim 12, wherein the media files are extracted by modifying a presentation file compatible with the presentation tool and subsequently segmenting the presentation file into a plurality of media files.

19. The method of claim 1, wherein extracting the course includes storing portions or attributes of the content items as annotations or attributes of course structural elements.

20. The method of claim 19, wherein the content items comprise slides in a slide show presentation and lecture notes appended to each slide are stored as annotations to structural elements corresponding to each slide.

21. The method of claim 19, wherein the content items comprise slides in a slide show presentation and a digital image associated with each slide is stored as a thumbnail image for a structural element corresponding to each slide.

22. The method of claim 1, further comprising modifying the course using a course author tool.

23. The method of claim 22, wherein modifying includes selecting to edit a course structural element and, in response to the selection, automatically launching the presentation tool to edit one or more content items associated with the course structural element.

24. The method of claim 22, wherein modifying includes selecting to view a course structural element and, in response to the selection, automatically launching the presentation tool to view one or more content items associated with the course structural element.

25. The method of claim 22, wherein:
extracting the course includes extracting media files that correspond to the course structural elements of the course structure; and
modifying the course using the course author tool includes:
selecting to edit a media file corresponding to a course structural element and stored using a file extension, and
automatically launching an application based on the file extension, the application being configured to edit the selected media file.

26. The method of claim 1, further comprising:
receiving from the presentation tool a second set of one or more content items associated with a sequential order, the second set corresponding to the first set further modified by the presentation tool; and
automatically updating the course structure based on differences between the first set and the second set of one or more content items.

27. A system for creating an e-learning course comprising:
a presentation tool configured to generate a first set of one or more content items associated with a sequential order; and
an extractor configured to receive the set of one or more content items, enable a user to determine a course structure by associating one or more portions or content items of the set of content items with course structural elements, and extract the course associated with the course structure.

28. The system of claim 27 further comprising a course author tool configured to import the course and enable a user to modify the course structural elements or relations between the course structural elements.

29. The system of claim 27, wherein the content items comprise one or more types of presentation media.

30. The system of claim 29, wherein the types of presentation media include a text, a table, a graphic, an image, an audio clip, a video clip, and a slide.

31. The system of claim 27, wherein the extractor is configured to enable a user to determine a course structure by creating a course structure.

32. The system of claim 27, wherein the extractor is configured to enable a user to determine a course structure by enabling a user to edit a course structure.

33. The system of claim 32, wherein enabling a user to edit a course structure includes enabling a user to group a portion of the first set of content items with a learning object.

34. The system of claim 32, wherein enabling a user to edit a course structure includes enabling a user to group a portion of the first set of content items with a sequence knowledge item.

35. The system of claim 32, wherein enabling a user to edit a course structure includes enabling a user to group a portion of the first set of content items with a sub course.

36. The system of claim 32, wherein enabling a user to edit a course structure includes enabling a user to change a title of a course structural element.

37. The system of claim 25, wherein the extractor is configured to extract the course by extracting course structure files and media files associated with the course structure.

38. The system of claim 37, wherein the extractor is configured to extract the course by specifying the file format for the media files.

39. The system of claim 37, wherein the extractor is configured to extract the media files in a file format supported by the presentation tool but modified for interpretation by the course author tool.

40. The system of claim 37, wherein the extractor is configured extract the course by storing the course structure files and media files in a manner that is compatible with the course author tool.

41. The system of claim 37, wherein the course structural elements include learning objects and storing includes storing all files associated with a learning object inside a directory.

42. The system of claim 41, wherein the directory contains a course structure file and one or more media files corresponding to knowledge items associated with the learning object.

43. The system of claim 27, wherein the extractor is configured to extract the media files by modifying a presentation file compatible with the presentation tool and subsequently segmenting the presentation file into a plurality of media files.

44. The system of claim 27, wherein the extractor is configured to extract the course structure by storing portions or attributes of the content items as annotations or attributes of course structural elements.

45. The system of claim 44, wherein the content items comprise slides in a slide show presentation and the extractor is configured to store lecture notes appended to each slide as annotations to structural elements corresponding to each slide.

46. The system of claim 44, wherein the content items comprise slides in a slide show presentation and the extractor is configured to store a digital image associated with each slide as a thumbnail image for a structural element corresponding to each slide.

47. The system of claim 28, wherein the course author tool is configured to enable a user to modify the course structural elements by enabling the user to select to edit a course structural element and, in response to the selection, automatically launching the presentation tool to enable the user to edit one or more content items associated with the course structural element.

48. The system of claim 28, wherein the course author tool is configured to enable a user to modify the course structural elements by enabling the user to select to view a course structural element and, in response to the selection, automatically launching the presentation tool to enable the user to view one or more content items associated with the course structural element.

49. The system of claim 28, wherein:
the extractor is configured to extract the course structure by extracting media files that correspond to the course structural elements of the course structure; and
the course author tool is configured to modify the course structure by:
enabling a user to select to edit a media file associated with a course structural element and stored using a file extension, and
automatically launching an application based on the file extension, the application being configured to edit the selected media file.

50. The system of claim 27, wherein the extractor is further configured to:
receive from the presentation tool a second set of one or more content items associated with a sequential order, the second set corresponding to the first set further modified by the presentation tool; and
automatically update the course structure based on differences between the first set and the second set of one or more content items.

51. A user interface comprising:
a first interface element structured and arranged to enable perception of a set of one or more content items associated with a sequential order;
a second interface element structured and arranged to enable determination of a course structure by associating one or more portions or content items of the set of content items with course structural elements in response to user manipulation; and
a third interface element structured and arranged to enable extraction of a course associated with the course structure.

52. The user interface of claim 51, wherein the third interface element is structured and arranged to enable extraction of the course for importation into a course author tool.

53. The user interface of claim 51, wherein the first interface element graphically depicts the set of content items as a group of content item symbols.

54. The user interface of claim 51, wherein the second interface element comprises a window that includes a tree view of the course structure.

55. The user interface of claim 54, wherein the tree view graphically distinguishes between different types of structural elements through indentation.

56. The user interface of claim 54, wherein the tree view graphically distinguishes between different types of structural elements through the use of different graphical symbols.

57. The user interface of claim 51, wherein the course structural elements include at least one of a sub course, a learning object, and a knowledge item.
